(19) United States
(12) Patent Application Publication
(10) Pub. No.: US 2015/0100647 A1
(43) Pub. Date: Apr. 9, 2015

(54) RICH MEDIA MESSAGING SYSTEMS AND METHODS

(71) Applicant: Weaver Labs, Inc., San Francisco, CA (US)

(72) Inventors: Michael Agustin, Round Rock, TX (US); Hojun Jang, Seoul (KR); Benjamin Taylor, Quincy, MA (US); Daniel Treiman, Austin, TX (US)

(73) Assignee: Weaver Labs, Inc., San Francisco, CA (US)

(21) Appl. No.: 14/280,433

(22) Filed: May 16, 2014

Related U.S. Application Data
(60) Provisional application No. 61/887,216, filed on Oct. 4, 2013.

(51) Int. Cl. H04L 12/58

(52) U.S. Cl. CPC H04L 51/04
USPC 709/206

(57) ABSTRACT

In methods and systems, a textual portion of an electronic message from a first user device to a second user device is received. One or more contextual tags to represent a context of the textual portion are recommended. The recommending the one or more contextual tags is based at least in part on the receiving the textual portion. One or more rich media elements are recommended to represent the context of the textual portion. The recommending the one or more rich media elements is based at least in part on the one or more contextual tags. The one or more rich media elements and the textual portion are integrated into a rich media message. The rich media message is provided to the second device.

### CROSS-REFERENCE TO RELATED APPLICATIONS

This application claims priority to U.S. Provisional No. 61/887,216, filed Oct. 4, 2013, entitled “RICH MEDIA MESSAGING SYSTEMS AND METHODS, which is incorporated herein by reference.

### TECHNICAL FIELD

The technical field relates to computer systems and methods. More particularly, the technical field relates to computer systems and methods for electronic messaging.

### BACKGROUND

Electronic messaging systems have provided efficient tools for people to communicate and connect with one another. For example, electronic mail systems have provided electronic mail accounts with which people can electronically message each other. As another example, mobile messaging systems such as Short Message Services (SMS) and Multimedia Messaging Services (MMS) have allowed people to send electronic messages to and from mobile phones. As yet another example, social networking systems and web logging (“blogging”) systems have provided platforms for people to push electronic messages to their friends or followers.

A large portion of humanity uses an electronic messaging system in some capacity. Indeed, in many instances, electronic messaging systems are so popular that they are replacing postal mail and non-electronic modes of communication in many contexts. Though popular, electronic messaging systems have their limitations. Unfortunately, many electronic messaging systems limit the expressions that people can share with one another. Electronic messaging systems that facilitate a broad range of expressions would greatly expand the range of expressions that people can share with one another. Electronic messaging systems that are compatible with computer and network infrastructures would allow sharing in many contexts that traditional electronic messaging has proven popular.

### SUMMARY

In a method, a textual portion of an electronic message from a first user device to a second user device may be received. One or more contextual tags to represent a context of the textual portion are recommended. The recommending the one or more contextual tags may be based at least in part on the receiving the textual portion. One or more rich media elements are recommended to represent the context of the textual portion. The recommending the one or more rich media elements may be based at least in part on the one or more contextual tags. The one or more rich media elements and the textual portion are integrated into a rich media message. The rich media message may be provided to the second device.

The one or more rich media elements may comprise an image, a meme, a video, an interactive element, or an animated element. The one or more rich media elements may be customized by an artist to represent the one or more contextual tags. The one or more rich media elements may comprise a background image and a character icon image; and the rich media message may comprise a composite arrangement of the background image, the character icon image, and the textual portion of the electronic message, the composite arrangement visually providing the context of the textual portion.

In some embodiments, the rich media message, when displayed on the second user device, may be configured to display the one or more contextual tags, dates the one or more rich media elements were rendered, dates the one or more rich media elements were uploaded, locations the one or more rich media elements have been associated with, buildings that the one or more rich media elements have been associated with, one or more artists who created the one or more rich media elements, or semantics associated with the one or more rich media elements.

In some embodiments, recommending the one or more contextual tags may be based at least in part on language characteristics of the textual portion. Recommending the one or more contextual tags may be based at least in part on a location of the first user device when the first user device provided the textual portion. Recommending the one or more contextual tags may be based at least in part on a checkin history of the first user device. Recommending the one or more contextual tags may be based at least in part on social data associated with the first user device. Recommending the one or more contextual tags may comprise: ranking relevance of a plurality of the one or more tags with respect to the textual portion; and providing a ranked list of contextual tags. Recommending the one or more contextual tags may comprise adaptively choosing the one or more contextual tags for the first user device based on a tagging history of the first user device.

Recommending one or more rich media elements may comprise retrieving the one or more rich media elements from a rich media element datastore. Recommending one or more rich media elements may comprise determining whether the one or more rich media elements represent the one or more contextual elements, and if not, requesting rendition of the one or more rich media elements.

Providing the rich media message to the second user device may comprise instructing an application on the second user device to display the rich media message. The application comprises a native messaging application on the second user device. The application comprises a social networking application on the second user device.

The method may comprise receiving from the first user device one or more approved contextual tags; and wherein the recommending the one or more rich media elements is based at least in part on the one or more approved contextual tags. The method may comprise receiving from the first user device one or more approved rich media elements, and wherein the integrating the one or more rich media elements comprises integrating the one or more approved rich media elements into the rich media message.

A system may comprise: a tag datastore, a rich media element datastore, and a rich media message datastore; a first user device interface engine configured to interface with a first user device; a tag recommendation engine coupled to the tag datastore; a rich media element recommendation engine coupled to the rich media element datastore; a rich media creation engine coupled to the rich media message datastore; and a second user device interface engine configured to interface with a second user device. In operation: the user device interface engine may receive a textual portion of an electronic message from the first user device to the second user device. In operation, the tag recommendation engine may recommend one or more contextual tags to represent a context of the textual portion, the recommending the one or more contextual tags based at least in part on the receiving the textual portion. In operation, the rich media element recommendation engine may recommend the context of the textual portion, the recommending the one or more rich media elements based at least in part on the one or more contextual tags. In operation, the rich media message creation engine may integrate the one or more rich media elements and the textual portion into a rich media message. In operation, the second user device interface engine may provide the rich media message to the second user device.

A system may include: means for receiving a textual portion of an electronic message from a first user device to a second user; means for recommending one or more contextual tags to represent a context of the textual portion, the recommending the one or more contextual tags based at least in part on the receiving the textual portion; means for recommending one or more rich media elements to represent the context of the textual portion, the recommending the one or more rich media elements based at least in part on the one or more contextual tags; means for integrating the one or more rich media elements and the textual portion into a rich media message; and means for providing the rich media message to the second user. A textual portion of an electronic message from a first user device to a second user device is received.

Other features and embodiments are apparent from the accompanying drawings and from the following detailed description.

### BRIEF DESCRIPTION OF THE DRAWINGS

FIG. 1 depicts an example of a rich media messaging system, according to some implementations.

FIG. 2 depicts an example of data flow within the context of a rich media messaging system, according to some implementations.

FIG. 3 depicts an example of a rich media communication engine, according to some implementations.

FIG. 4 depicts a flowchart of an example of a method for providing rich media messaging, according to some implementations.

FIG. 5 depicts an example of a tag selection engine, according to some implementations.

FIG. 6A depicts a flowchart of an example of a method for recommending contextual tags for an electronic message, according to some implementations.

FIG. 6B depicts a flowchart of an example of a method for retrieving a stored contextual tag for an electronic message, according to some implementations.

FIG. 7 depicts an example of a rich media message creation engine, according to some implementations.

FIG. 8 depicts a flowchart of an example of a method for recommending rich media elements for electronic messages, according to some implementations.

FIG. 9 depicts an example of a digital device, according to some implementations.

FIG. 10 depicts a preview of an opening screen of a rich media messaging application, according to some implementations.

FIG. 11 depicts a preview of an account creation screen of a rich media messaging application, according to some implementations.

FIG. 12 depicts a preview of a sign in screen of a rich media messaging application, according to some implementations.

FIG. 13 depicts a preview of an account management screen of a rich media messaging application, according to some implementations.

FIG. 14 depicts a preview of a story creation screen of a rich media messaging application, according to some implementations.

FIG. 15 depicts a preview of a story creation screen of a rich media messaging application, according to some implementations.

FIG. 16 depicts a preview of a story creation screen of a rich media messaging application, according to some implementations.

FIG. 17 depicts a preview of a story creation screen of a rich media messaging application, according to some implementations.

FIG. 18 depicts a preview of a story creation screen of a rich media messaging application, according to some implementations.

FIG. 19 depicts a preview of a story creation screen of a rich media messaging application, according to some implementations.

FIG. 20 depicts a preview of a story creation screen of a rich media messaging application, according to some implementations.

### DETAILED DESCRIPTION

Electronic messaging systems include systems that provide electronic mail, mobile messaging, social networking, blogging, and other messaging techniques. Typically, electronic messaging systems require users to communicate via textual input. For example, many electronic mail systems require users to compose an email through a keyboard or other textual input device. As another example, mobile messaging systems such as Short Message Services (SMS) and Multimedia Messaging Services (MMS) may require users to compose a mobile message using a textual interface on a mobile device. As yet another example, messages sent in social networking systems or web logging (“blogging”) systems are usually based on textual input. In each of these examples, text from a keyboard forms the basis of an electronic message that is provided between two or more users. Due to the wide popularity of many of these technologies, people are accustomed to typing text in order to communicate.

In many electronic messaging systems, however, it is often difficult to express ideas that are not easily represented by text. Messages often appear as undecipherable walls of text. Most electronic messaging systems allow users to add non-textual content, such as images, music, video, interactive content, and other content. However, in most electronic messaging systems, non-textual content is disembodied from text. To continue the foregoing examples, in the case of electronic mail systems, users typically add a content item as an attachment to an email. The content item is added to an email without any connection to the text of the email. A user wishing to explain meaning using the content is required to add the meaning of the content into the textual portions of the email. Similarly, a content item added to a mobile message, a social networking message, or a blog must be explained using accompanying text. In each of these examples, the text of an electronic message is used to explain non-textual content. However, in none of these examples does the content item serve to explain or provide context to the textual portions of the electronic message.

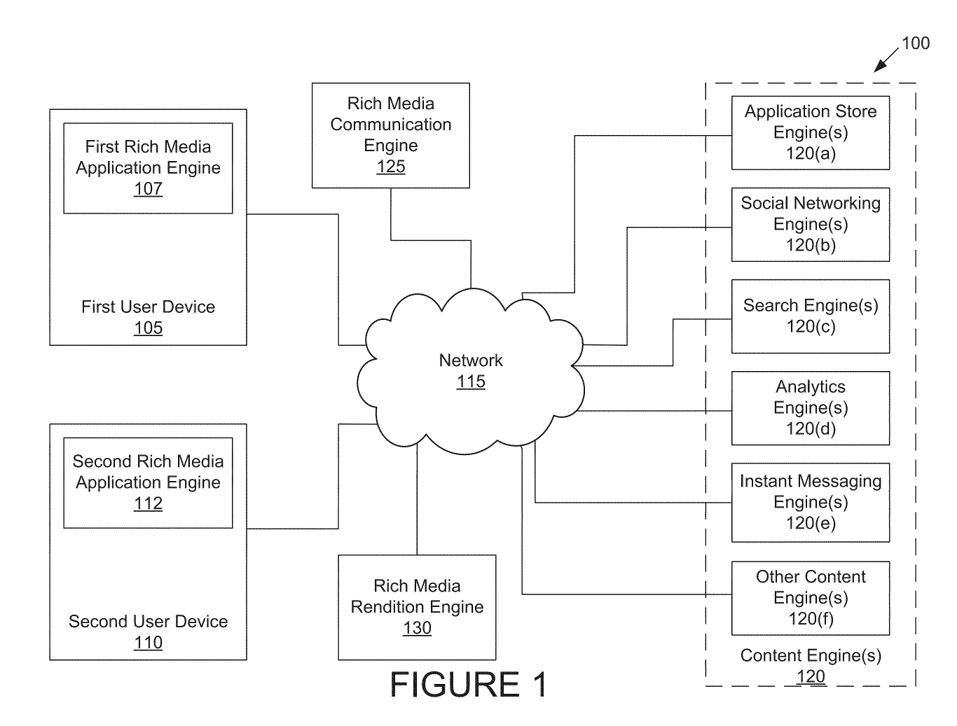

FIG. 1 depicts an example of a rich media messaging system 100, according to some implementations. The rich media messaging system 100 may allow users to compose, share, receive, and manage rich media messages. More specifically, the rich media messaging system 100 may provide a platform for users to express ideas with text and rich media elements. Examples of rich media elements include images, memes, video, interactive elements, and animation elements. In the rich media messaging system 100, text and rich media elements may be woven together to visually convey the context and meaning of the text. The arrangement of rich media elements within a rich media message may ensure that the particular rich media elements give full effect to the context of items in the rich media message. Moreover, the arrangement of rich media elements in a rich media message may ensure that a character icon and a background image for with a particular user's electronic message are associated a rich media rendition of that electronic message. Within the rich media message, rich media elements may be adapted to link back to their creators and/or brand owners. The rich media elements in rich media messages may be associated with a reference, such as a hashtag.

In the rich media messaging system 100, rich media elements may be rendered by artists, including amateur artists, professional artists, or some combination thereof. The rich media elements may be customized to represent particular contextual tags. The rich media elements may be obtained from a rich media library. The rich media elements may include rich and high-quality representations of the various contexts. The contexts may be signified by the words or phrases that people are likely to use to communicate with one another. In some implementations, the rich media elements may include representations of the various words or phrases that a particular user is likely to use in his or her communications with other users. The resulting rich media message may allow users to visually express ideas to each other. By mixing illustration, interactivity, and traditional textual communications, the visually-driven communications in the rich media messaging system 100 allow a far greater range of expressions than would be possible through purely text-based electronic messaging systems. More specifically, the visually-driven communications of the rich media messaging system 100 allow users to share content in a visually-minded manner. As a result, the visually-driven communications of the rich media messaging system 100 provide the ability to explain many concepts that are not easily expressible in text.

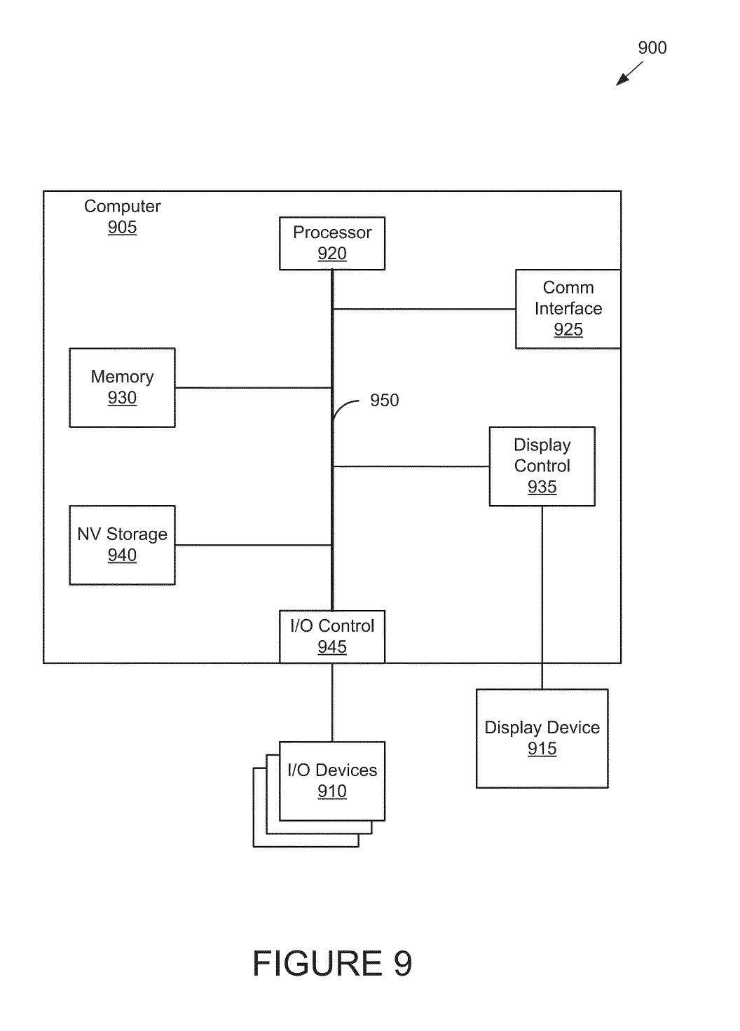

The rich media messaging system 100 may include a first user device 105, a second user device 110, a network 115, content engine(s) 120, a rich media communication engine 125, and a rich media rendition engine 130. One or more of the first user device 105, the second user device 110, the network 115, the content engine(s) 120, the rich media communication engine 125, and the rich media rendition engine 130 may comprise a digital device. As such, one or more of the first user device 105, the second user device 110, the network 115, the content engine(s) 120, the rich media communication engine 125, and the rich media rendition engine 130 may contain one or more elements of the digital device 900 shown in FIG. 9. One or more of the first user device 105, the second user device 110, the network 115, the content engine(s) 120, the rich media communication engine 125, and the rich media rendition engine 130 may comprise one or more of a desktop computer, a laptop computer, a tablet device, a mobile phone, a personal digital assistant (PDA) or other digital device.

Further, one or more of the first user device 105, the second user device 110, the network 115, the content engine(s) 120, the rich media communication engine 125, and the rich media rendition engine 130 may comprise an engine. An “engine,” as used herein, is a device with one or more shared or dedicated processors and memory configured to execute instructions on the one or more shared or dedicated processors. It is noted that the term “engine,” as used herein, does not refer to modules that are purely software or algorithms that consist of mental steps that can be performed in a human being's head.

In the example of FIG. 1, the first user device 105 may be associated with a first user. The first user device 105 may support access to one or more of the content engine(s) 120. The first user device 105 may comprise a first rich media application engine 107. The first rich media application engine 107 may allow the first user device 105 to compose, share, and receive rich media messages. In some implementations, the first rich media application engine 107 may manage the first user's access to rich media messaging. To this end, the first rich media application engine 107 may facilitate creation, sign-in, and management of one or more rich media messaging accounts associated with the first user.

The first rich media application engine 107 may connect the first user to other users, such as a second user, who, in the example of FIG. 1, is associated with the second user device 110. Connections may be facilitated through the use of address books stored on or accessible to the first user device 105. For instance, the first rich media application engine 107 may allow the first user to access a locally stored or remotely accessible address book. As other examples, the first rich media application engine 107 may allow the first user to manually enter the usernames of other users, or link the usernames of other users based on information from a third-party social network or a third-party blogging service that is managed independently of rich media messaging services.

The first rich media application engine 107 may facilitate composition, sharing, reception, and management of rich media messages. The first rich media application engine 107 may display to the first user one or more story creation screens. The story creation screens may allow the first user to select one or more other users who are to receive rich media messages. The story creation screens may also allow the first user to provide a textual portion of an electronic message to the rich media communication engine 125. A “textual portion” of an electronic message, as used herein, is any text that a user can enter for the electronic message. The textual portion may include a part or all of the subject, body, or other field of the electronic message.

In various implementations, the first rich media application engine 107 may receive from the rich media communication engine 125 tag recommendations for the textual portion of the electronic message, and may allow the first user to accept tags that represent the context or meaning of the textual portion. The first rich media application engine 107 may also receive from the rich media communication engine 125 rich media element recommendations that are based on the tags. The rich media element recommendations may or may not require approval by the first user. The first rich media application engine 107 may receive instructions to weave the rich media element recommendation, along with the textual portion of the electronic message, into a rich media message. The rich media element recommendations may or may not require approval by the first user. In some implementations, the first rich media application engine 107 may display an integrated rich media message to the first user. The first rich media application engine 107 may facilitate sending the rich media message to the rich media communication engine 125, and ultimately, to other users and/or the content engine(s) 120.

In some implementations, the first rich media application engine 107 may be implemented as a standalone application that is native to the first user device 135. As a standalone application, the first rich media application engine 107 may be designated its own memory space and/or processor space each time the first rich media application engine 107 starts up. However, in various implementations, the first rich media application engine 107 may be implemented as a portion of a container application, such as Internet browser, on the first user device 105. As a portion of a container application, the first rich media application engine 107 may be allocated a portion of memory space and/or processor space that has been allocated to the container application. For instance, as a portion of a container application, the first rich media application engine 107 may be configured to display as a webpage on an Internet browser of the first user device 105.

In the example of FIG. 1, the second user device 110 may support access to one or more of the content engine(s) 120. The second user device 110 may connect the second user to other users, such as the first user, who, as discussed in this example, is associated with the first user device 105. The second user device 110 may comprise a second rich media application engine 112. The second rich media application engine 112 may allow the second user device 110 to compose, share, and receive rich media messages. The second rich media application engine 112 may also connect the second user to other users, such as the first user. In various implementations, the second rich media application engine 112 may facilitate composition, sharing, reception, and management of rich media messages. The second rich media application engine 112 may be implemented as a standalone application on the second user device 110 or as a portion of a container application on the second user device 110. The second rich media application engine 112 may operate similarly to the first rich media application engine 107, discussed herein.

In the example of FIG. 1, the network 115 may couple the first user device 105, the second user device 110, the content engine(s) 120, the rich media communication engine 125, and the rich media rendition engine 130 to one another. The network 115 may comprise any computer network. The network 115 may include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. In various implementations, the network 115 may be implemented as a computer-readable medium, such as a bus, that couples components of a single computer together. For illustrative purposes, it is assumed the network 115 broadly includes, as understood from relevant context, anything from a minimalist coupling of the components illustrated in the example of FIG. 1, to every component of the Internet and networks coupled to the Internet.

In various implementations, the network 115 may include technologies such as Ethernet, 802.11, worldwide interoperability for microwave access (WiMAX), 3G, 4G, CDMA, GSM, LTE, digital subscriber line (DSL), etc. The network 115 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 115 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

The content engine(s) 120 may provide and/or receive content to one or more of the first user device 105, the second user device 110, the rich media communication engine 125, and the rich media rendition engine 130. In various implementations, the content engine(s) 120 may be administered by one or more entities distinct from the entity administering the rich media communication engine 125 and/or the rich media rendition engine 130. The content engine(s) 120 may include application store engine(s) 120(a), social networking engine(s) 140, search engine(s), analytics engine(s) 120(d), analytics engine(s) 120(d), instant messaging engine(s) 120(e), and other content engine(s) 120(f). One or more of the application store engine(s) 120(a), social networking engine(s) 120(b), search engine(s) 120(c), analytics engine(s) 120(d), instant messaging engine(s) 120(e), and other content engine(s) 120(f) may be coupled to one another over the network 115. It is noted that, although FIG. 1 shows the content engine(s) 120 as grouped together, such a grouping does not necessarily imply that the content engine(s) 120 are administered by a common entity. In various implementations, however, the content engine(s) 120 may be administered by a common entity.

The application store engine(s) 120(a) may include a digital distribution platform for the deployment and management of applications and/or components of applications. The application store engine(s) 120(a) may be integrated into a known application store, including a third-party application store, such as the iTunes® or Google Play® application stores. The application store engine(s) may also be distinct from third-party application stores. Some or all of the application store engine(s) 120(a) may be administered by the entity that administers the rich media communication engine 125, in various implementations.

In various implementations, the application store engine(s) 120(a) may provide one or more instances of the first rich media application engine 107 for installation on the first user device 105. The application store engine(s) 120(a) may also provide one or more instances of the second rich media application engine 112 for installation on the second user device 110. As a result, the application store engine(s) may allow users to search for applications. The application store engine(s) 120(a) may also categorize applications for purchase or download to user devices. In some implementations, the application store engine(s) 120(a) may facilitate updates of the first rich media application engine 107 and/or second rich media application engine 112.

In a specific implementation, application store engine(s) 120(a) may allow users to purchase, install and/or update rich media elements for rich media messages. For example, the application store engine(s) 120(a) may receive rich media elements from the rich media rendition engine 130, as discussed in more detail herein. The application store engine(s) 120(a) may also create packages of group rich media elements based on attributes of particular rich media elements and/or users who are likely to interact with particular rich media elements. The application store engine(s) 120(a) may determine prices of particular rich media elements and/or packages of rich media elements. The application store engine(s) 120(a) may include rich media elements rendered by amateur and professional artists.

The social networking engine(s) 120(b) may allow users to build and manage social relationships with one another. The social networking system 120(b) may include some or all of a known social networking system, including general social networking systems like Facebook®, professional social networking systems like LinkedIn®, blogging services like Twitter®, and other social networking systems. In a specific implementation, the social networking engine(s) 120(b) may allow users to authenticate access to the rich media communication engine 125. To this end, the social networking engine(s) 120(b) may provide authentication credentials (e.g., a username and password) for account creation and/or management with respect to the rich media communication engine 125. In a specific implementation, the social networking engine(s) 120(b) may receive rich media messages from the rich media communication engine 125. The social networking system 120(b) may also facilitate sharing of rich media messages between users of the social networking engine(s) 120(b). In some implementations, the rich media communication engine 125 may access the functionalities of the social networking engine(s) 120(b) through one or more application programming interfaces (APIs). The one or more APIs may be exposed to the rich media communication engine 125 through the network 115.

The search engine(s) 120(c) may search for information that is accessible through the network 115. The search engine(s) 120 may receive search queries and may provide web pages, images, and other types of files based on the search queries. The search engine(s) 120(c) may correspond to known search systems, such as Google® search, Yahoo® search, Baidu® search, and other types of search systems. In various implementations, the rich media communication engine 125 may access the functionalities of the search engine(s) 120(c) through one or more APIs. The one or more APIs may be exposed to the rich media communication engine 125 through the network 115.

The analytics engine(s) 120(d) may provide measurement, collection, analysis, and reporting of data accessed or used by one or more of the first user device 105, the second user device 110, the rich media communication engine 125, and the rich media rendition engine 130. In a specific implementation, the analytics engine(s) 120(d) may monitor specific actions of the first user device 105, the second user device, the rich media communication engine 125, and the rich media rendition engine 130. More specifically, the analytics engine(s) 120(d) may monitor how users interact with the first rich media application engine 107 and/or the second rich media application engine 112. The analytics engine(s) 120(d) may further correlate the monitored actions with the likelihood that users will take a future action, e.g., make a particular purchase or view a particular web page. The analytics engine(s) 120(d) may correspond to a known analytics system such as Google Analytics®. In various implementations, the rich media communication engine 125 may access the functionalities of the analytics engine(s) 120(d) through one or more APIs. The one or more APIs may be exposed to the rich media communication engine 125 through the network 115.

The instant messaging engine(s) 120(e) may allow the first user device 105 to send instant messages to the second user device 110. The instant messaging engine(s) 120(e) may be implemented as a portion of a web-based instant messaging system, in some implementations. The instant messaging engine(s) 120(e) may also be implemented as a portion of an SMS or MMS system. In various implementations, the rich media communication engine 125 may access the functionalities of the instant messaging engine(s) 120(e) through one or more APIs. The one or more APIs may be exposed to the rich media communication engine 125 through the network 115.

The other content engine(s) 120(f) may include sources of web pages, images, video, music, and other content. The other content engine(s) 120(f) may provide content to one or more of the first user device 105, the second user device 110, the rich media communication engine 125, and the rich media rendition engine 130. The other content engine(s) 120(f) may also provide content to one or more of the application store engine(s) 120(a), social networking engine(s) 140, search engine(s), analytics engine(s) 120(d), analytics engine(s) 120(d), and instant messaging engine(s) 120(e).

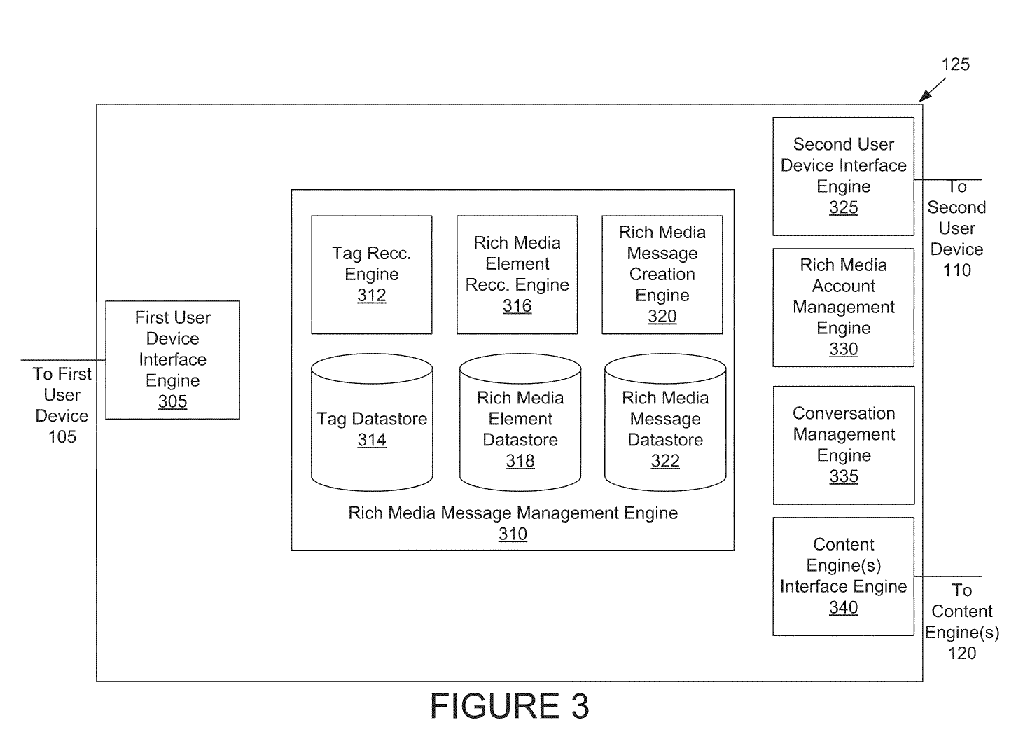

The rich media communication engine 125 may provide rich media management services to the first rich media application engine 107 and the second rich media application engine 112. The rich media communication engine 125 may allow users to compose, share, receive, and manage rich media messages to each other and to the content engine(s) 120. In a specific implementation, the rich media communication engine 125 may receive a textual portion of an electronic message from the first rich media application engine 107. The rich media communication engine 125 may evaluate the textual portion for contextual information so that the meaning of the textual portion may be determined based on the contextual information. The rich media communication engine 125 may further recommend tags for the textual portion. The rich media communication engine 125 may recommend, based on approved tags, rich media elements that correspond to the textual portion of the electronic message. The rich media communication engine 125 may also weave approved rich media elements and the textual portion of the electronic message into a rich media message. In various implementations, the rich media communication engine 125 may facilitate transmission of the rich media message to the second rich media application engine 112 and/or the content engine(s) 120. FIG. 3 shows the rich media communication engine 125 in greater detail.

The rich media rendition engine 130 may provide rich media elements to the rich media communication engine 125 and/or the content engine(s) 120. The rich media rendition engine 130 may be associated with an artist. The artist may comprise an amateur artist or a professional artist, in various implementations. The rich media rendition engine 130 may allow the artist to create and provide rich media elements. In some implementations, the rich media rendition engine 130 may be managed by the same entity that manages the rich media communication engine 125. In a specific implementation, the rich media rendition engine 130 may provide the art created by the artist to the application store engine(s) 102(a) and/or to other portions of the content engine(s) 120.

In the example of FIG. 1, only two user devices, namely the first user device 105 and the second user device 110, are shown in the rich media messaging system 100. However, it is noted that, in various implementations, the rich media messaging system 100 may include only one user device or more than two user devices. In some implementations, the functionalities of multiple rich media communication applications may reside on a single device. For instance, a single user device may support multiple user accounts, with each user account facilitating the functionalities of a different rich media communication application. It is noted that other variations are possible without departing from the scope and substance of the inventive concepts discussed herein.

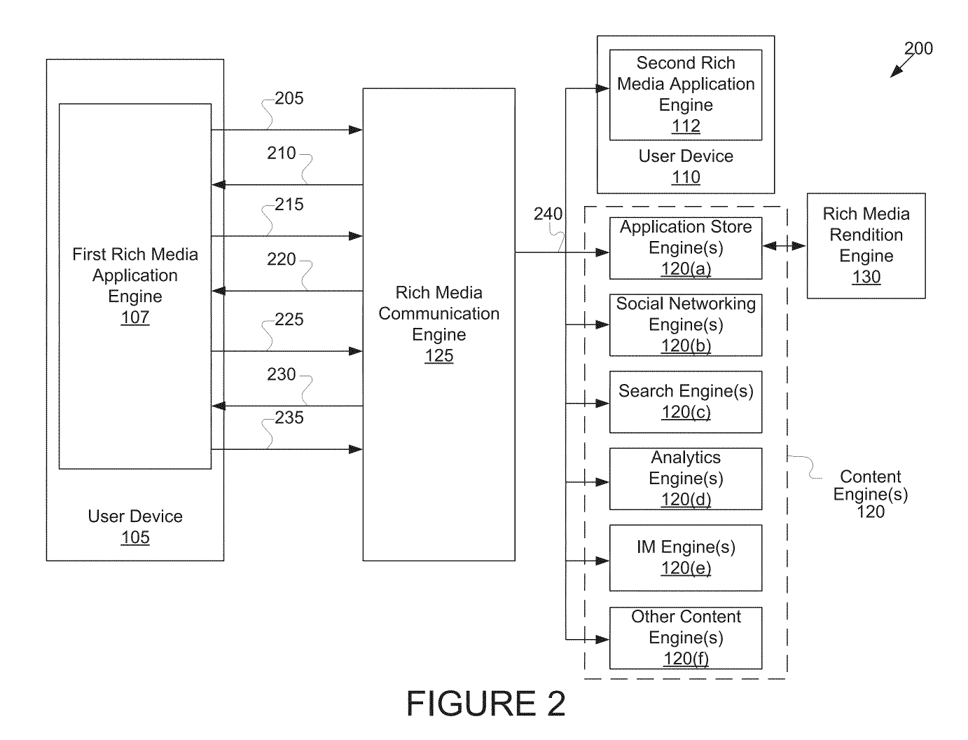

FIG. 2 depicts an example of data flow within the context of a rich media messaging system 200, according to some implementations. The rich media messaging system 200 may include: a first user device 105, a second user device 110, content engine(s) 120, a rich media communication engine 125, and a rich media rendition engine 130. As discussed, the first user device 105 may include a first rich media application engine 107, the second user device 110 may include a second rich media application engine 112, and the content engine(s) 120 may comprise application store engine(s) 120(a), social networking engine(s) 140, search engine(s), analytics engine(s) 120(d), analytics engine(s) 120(d), instant messaging engine(s) 120(e), and other content engine(s) 120(f). Elements of the rich media messaging system 200 in FIG. 2 have like reference numerals to the elements of the rich media messaging system 100 shown in FIG. 1.

At module 205, the first rich media application engine 107 may provide a request to initiate rich message composition to the rich media communication engine 125. In a specific implementation, the first rich media application engine 107 may load a startup screen and then authenticate access to rich media messaging services. Authentication credentials may comprise a username and a password. In various implementations, the first rich media application engine 107 may authenticate access using a user's credentials from a third-party, such as a third party social networking system. The first rich media application engine 107 may further request that a message composition window be populated with data from the rich media communication engine 125.

At module 210, the rich media communication engine 125 may instruct, in response to the request to initiate rich message composition, the first rich media application engine 107 to provide a rich media message composition window. The rich media message composition window may include fields for intended recipient(s), a subject, and a body. The intended recipient(s) field may be configured to be populated from an address book. The intended recipient(s) field may also be configured to be populated manually. The subject field and/or the body field may be configured to receive a textual portion of an electronic message. That is, a user may be able to fill in the subject field and/or the body field with a keyboard on the first user device 105. In various implementations, the first user may then compose textual portions of an electronic message into the rich media message composition window.

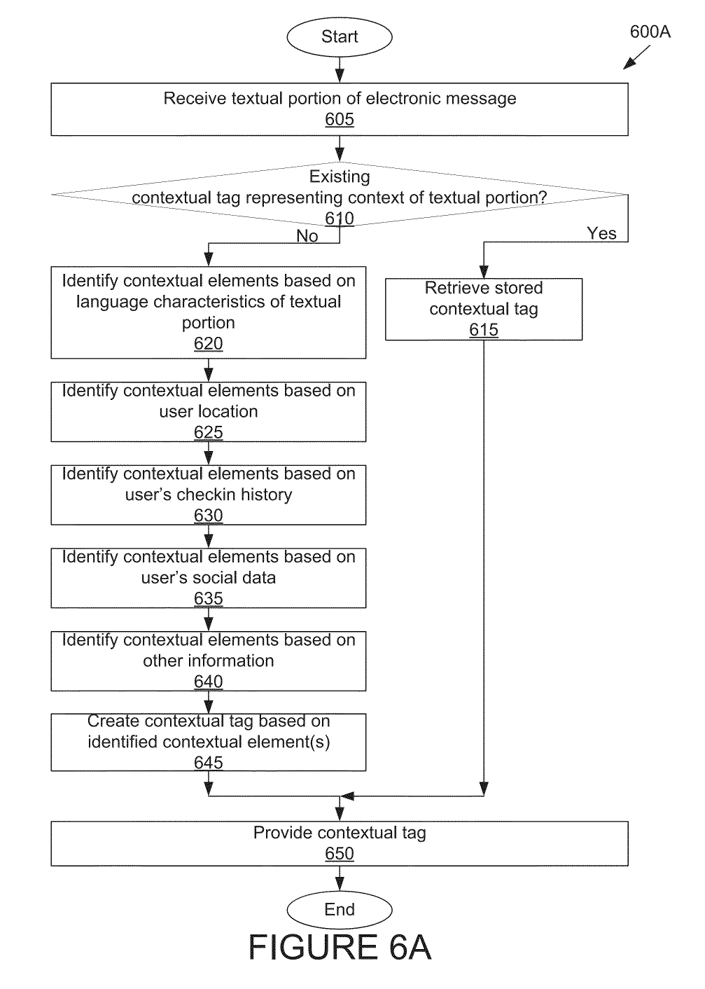

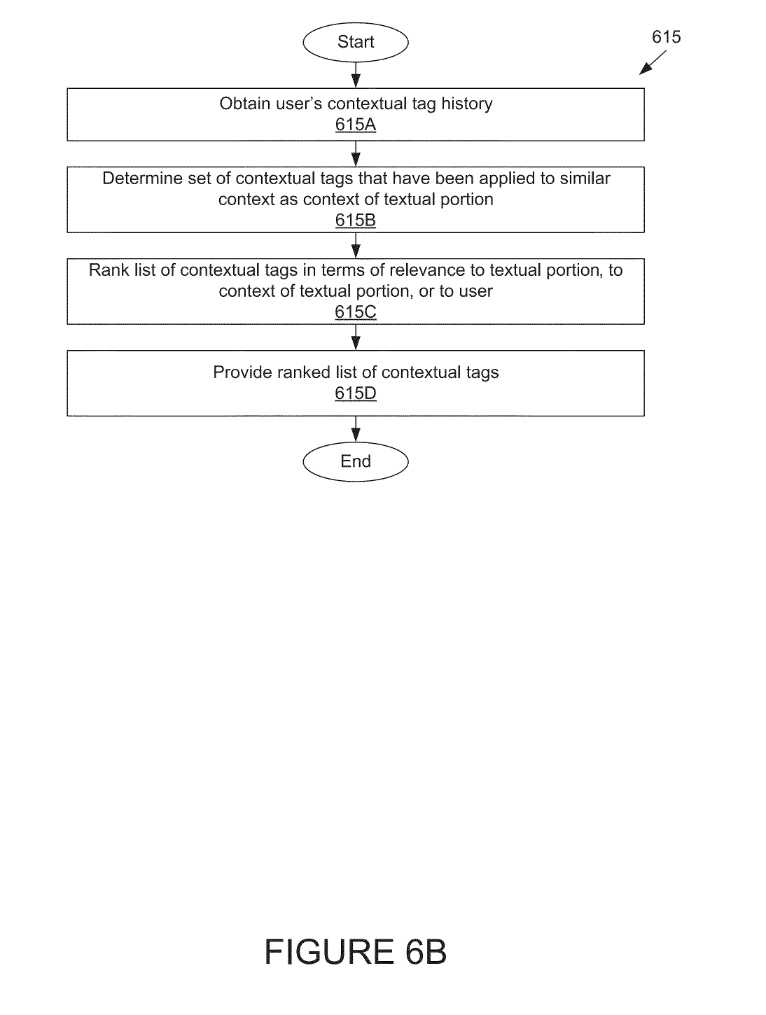

At module 215, the first rich media application engine 107 may provide the textual portion of the electronic message to the rich media communication engine 125. The rich media communication engine 125 may perform contextual processing on the textual portion of the textual portion to determine context and meaning of the textual portion. Contextual processing may involve processing attributes of the textual portion, including the textual portion's language structure, relationship to the first user's location, relationship to the first user's check-in history, relationship to the first user's social data, and other attributes. FIGS. 6A and 6B provide examples of flowcharts of methods that the rich media communication engine 125 may use in processing the context of the textual portion.

At module 220, the rich media communication engine 125 may provide contextual tag recommendations to the first rich media application engine 107. The first rich media application engine 107 may display the textual tag recommendations in the rich media message composition window. In a specific implementation, the first rich media application engine 107 may provide the contextual tag recommendations as selectable elements within the rich media message composition window.

At module 225, the first rich media application engine 107 may provide approved contextual tags to the rich media communication engine 125. The rich media communication engine 125 may proceed to look up rich media element recommendations for the contextual tags. In a particular implementation, the rich media communication engine 125 may identify visual features for the contextual tags and may recommend rich media elements based on the identified visual features.

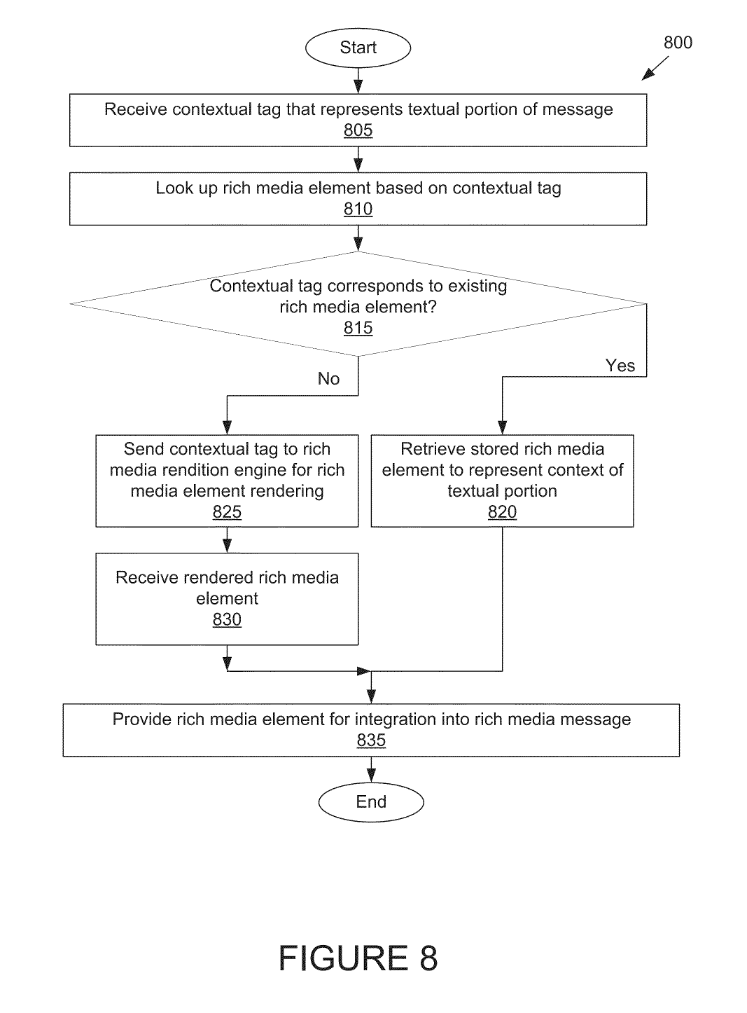

At module 230, the rich media communication engine 125 may provide rich media element recommendations to the first rich media application engine 107. The first rich media application engine 107 may display the rich media element recommendations as visual elements in the rich media message composition window. Such a display may allow the first user to select the visual elements to integrate into the rich media message as the first user continues to compose the rich media message. Such selection may constitute approval of the rich media elements that are recommended for the textual portion. FIG. 8 provides an example of a flowchart of a method that the rich media communication engine 125 may use in recommending rich media elements.

At module 235, the first rich media application engine 107 may provide an approved rich media message to the rich media communication engine 125. The approved rich media message may include the textual portions of the electronic message as well as a rich media rendition of the context and the meaning of the textual portions of the electronic message. The rich media communication engine 125 may subsequently prepare a finalized rich media message for transmission to other devices and engines.

At module 240, the rich media communication engine 125 may provide the finalized rich media message to the second rich media application engine 112 and to the content system(s) 120. To provide the finalized rich media message to the second rich media application engine 112, the rich media communication engine 125 may instruct the second rich media application engine 112 to display the finalized rich media message in a message window. To provide the finalized rich media message to the content system(s) 120, the rich media communication engine 125 may instruct the content system(s) 120, through API calls or otherwise, to display the finalized rich media message.

FIG. 3 depicts an example of a rich media communication engine 125, according to some implementations. The rich media communication engine 125 may include a first user device interface engine 305, a rich media message management engine 310, a second user device interface engine 325, a rich media account management engine 330, a conversation management engine 335, and a content engine(s) interface engine 340.

The first user device interface engine 305 may receive data from and send data to the first user device 105. In various implementations, the first user device interface engine 305 may provide an interface to the first rich media application engine 107.

The rich media message management engine 310 may create and manage rich media messages. The rich media message management engine 310 may include a tag recommendation engine 312, a tag datastore 314, a rich media element recommendation engine 316, a rich media element datastore 318, a rich media message creation engine 320, and a rich media message creation datastore 322.

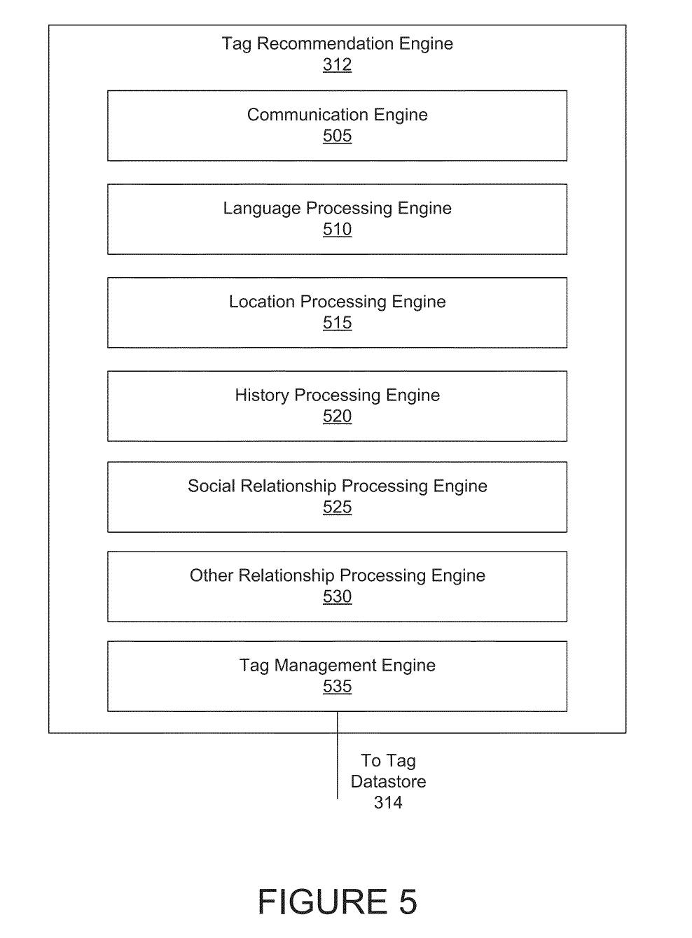

The tag recommendation engine 312 may provide tag recommendations for textual strings. In some implementations, the tag recommendation engine 312 may receive a textual string from the first user device interface engine 305. The tag recommendation engine 312 may determine the context and meaning of the textual string based on attributes of the textual string and the relationship of the textual string to the first user. In some implementations, the tag recommendation engine 312 may look up existing tags stored in the tag datastore 314 for particular textual strings. Recommended tags may appear in the user interface of the first rich media application engine 107 as words that pop and can be selected as the first user composes a message. FIG. 5 shows the tag recommendation engine 312 in greater detail.

The tag datastore 314 may store a set of tags. The tag datastore 314 may index the tags so that the tag recommendation engine 312 can efficiently recommend stored tags. In various implementations, tags may be indexed by specific contexts, such as by language structure, user location, user history, user social relationship, and other contexts. For instance, the tag datastore 314 may index the tag “Traveling” with the language “on the road” from the first user.

The rich media element recommendation engine 316 may provide rich media element recommendations for tags. In various implementations, the rich media element recommendation engine 316 may receive approved tags from the first user device interface engine 305. The rich media element recommendation engine 316 may determine visual properties of approved tags to recommend rich media elements for the approved tags. In various implementations, the rich media element recommendation engine 316 may look up existing rich media elements stored in the rich media element datastore 318. If there are no rich media elements in the rich media element datastore 318 for a specific tag, the rich media element recommendation engine 316 may request rendering of visual media elements for the specific tag.

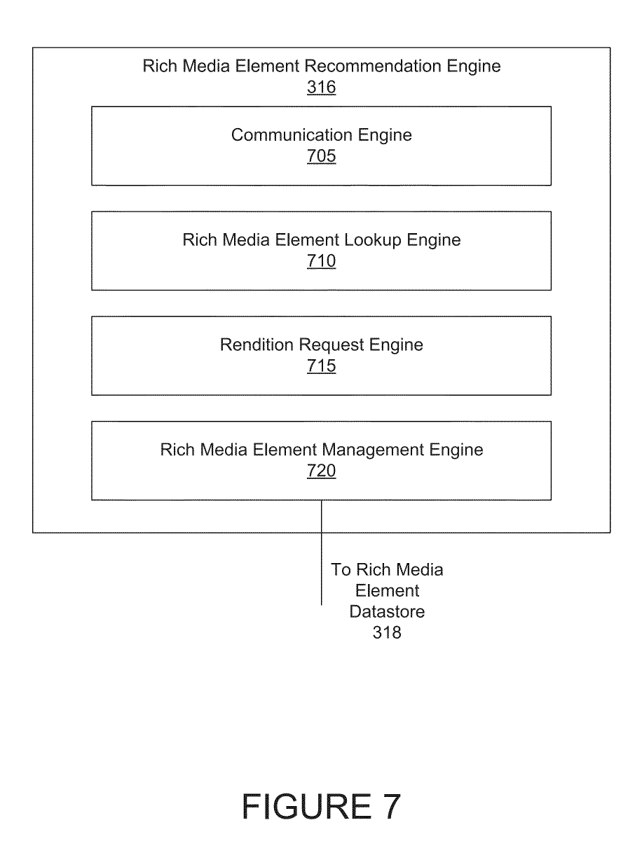

In various implementations, the rich media element recommendation engine 316 may support visual tagging. That is the rich media element recommendation engine 316 may embed the contextual tags used to arrive at a particular rich media element as metadata. As part of visual tagging, the rich media element recommendation engine 316 may also embed things like the dates a rich media element was rendered or uploaded, the potential contexts associated with the rich media element, the locations the rich media element has been associated with, the buildings that the rich media element has been associated with or used to signify, the artist who created the rich media element, semantics associated with the rich media element, and other information. The visual tag may be viewed by the second user when the second user hovers over a rich media message containing the particular rich media element. When the second user views the visual tag, the second user may, in essence, be engaging in a form of discovery of the rich media elements available in the rich media messaging system 100. FIG. 7 shows the rich media element recommendation engine 316 in greater detail.

The rich media element datastore 318 may store a set of rich media elements. The rich media element datastore 318 may index the rich media elements so that the rich media element recommendation engine 316 can efficiently recommend stored rich media elements. In various implementations, rich media elements may be indexed by specific visual properties likely to be associated with tags. For example, the rich media element datastore 318 may index a rich media image of an airport with the tag “Traveling.”

The rich media message creation engine 320 may create rich media messages based on approved rich media elements and the textual portions of the electronic message. In various implementations, the rich media message creation engine 320 may place rich media elements to give context and meaning to the textual portions. The rich media message creation engine 320 may base the rich media messages on libraries of preexisting rich media elements. The rich media message creation engine 320 may arrange particular rich media elements within a rich media message to ensure that the particular rich media elements give full effect to the context of items in the rich media message.

In some implementations, the particular rich media elements may include at least the textual portion of the electronic message, a character image that represents the first user in the rich media message, and a background image that represents a portion of the context of the textual portion of the electronic message. The rich media message creation engine 320 may associate the character image, the background image, and the textual portion with a common dialog that is provided to the second rich media application engine 112. The rich media message creation engine 320 may associate the first rich media image of the airport, the second rich media image of the character, and the textual annotation into a common chat dialog window that is provided to the second rich media application engine 112. As a result, the rich media message creation engine 320 may provide a character driven interface for social communications. In the character driven interface, the first user will appear as if he is talking to the second user in a virtual environment. The virtual environment may include a background image that represents the context of what the first user is trying to say to the other user.

As an example, the rich media message creation engine 320 may integrate a first rich media image of an airport scene, a second rich media image of a character representing the first user, and the text “on the road again” into a rich media message. The rich media message may contain, as the background, the first rich media image of the airport, as a subject, the second rich media image of the character, and as a textual annotation to the character, the text “on the road again.” The rich media message creation engine 320 may arrange each of the first rich media image of the airport, the second rich media image of the character, and the textual annotation in a manner that shows that the character is sitting in an airport with the text “on the road again” residing in a thought bubble associated with the character. The rich media message creation datastore 322 may store a rich media messages. The rich media message creation engine 320 may access the rich media message creation datastore 322 to create rich media messages. The rich media message creation engine 320 may associate the first rich media image of the airport, the second rich media image of the character, and the textual annotation into a common chat dialog window that is provided to the second rich media application engine 112.

In various implementations, the rich media message creation engine 320 may support visual tagging of rich media messages. That is, the rich media message creation engine 320 may ensure that contextual tags that are embedded as metadata in a specific rich media element are viewable by the second user when the second user hovers over the specific rich media message. Such viewing of visual tags by the second user may support discovery of the rich media elements available in the rich media messaging system 100. To continue the foregoing example, suppose the text “on the road again” were used to compose a rich media message that had, as the background, the first rich media image of the airport, as a subject, the second rich media image ’ the character, and as a textual annotation to the character, the text “on the road again.” In this example, the rich media message creation engine 320 may allow the second user to view the contextual tag “Traveling” when the second user hovered over the rich media message in the second rich media application.

The second user device interface engine 325 may receive data from and send data to the second user device 110. In some implementations, the second user device interface engine 325 may provide an interface to the second rich media application engine 112.

The rich media account management engine 330 may manage a user account associated with the first user. In various implementations, the rich media account management engine 330 may receive user credentials and may authenticate access to rich media messaging services.

The conversation management engine 335 may manage aspects of conversations between the first rich media application engine 107 and the second rich media application engine 112. In various implementations, the conversation management engine 335 may manage chat user interfaces related to conversations between the first rich media application engine 107 and the second rich media application engine 112. The conversation management engine 335 may also send and receive alerts related to conversations between the first rich media application engine 107 and the second rich media application engine 112. The conversation management engine 335, in various implementations, may maintain an internal social networking system for users of rich media messaging.

The content engine(s) interface engine 340 may receive data from and send data to the content system(s) 120. In some implementations, the content engine(s) interface engine 340 may provide an interface to the content system(s) 120.

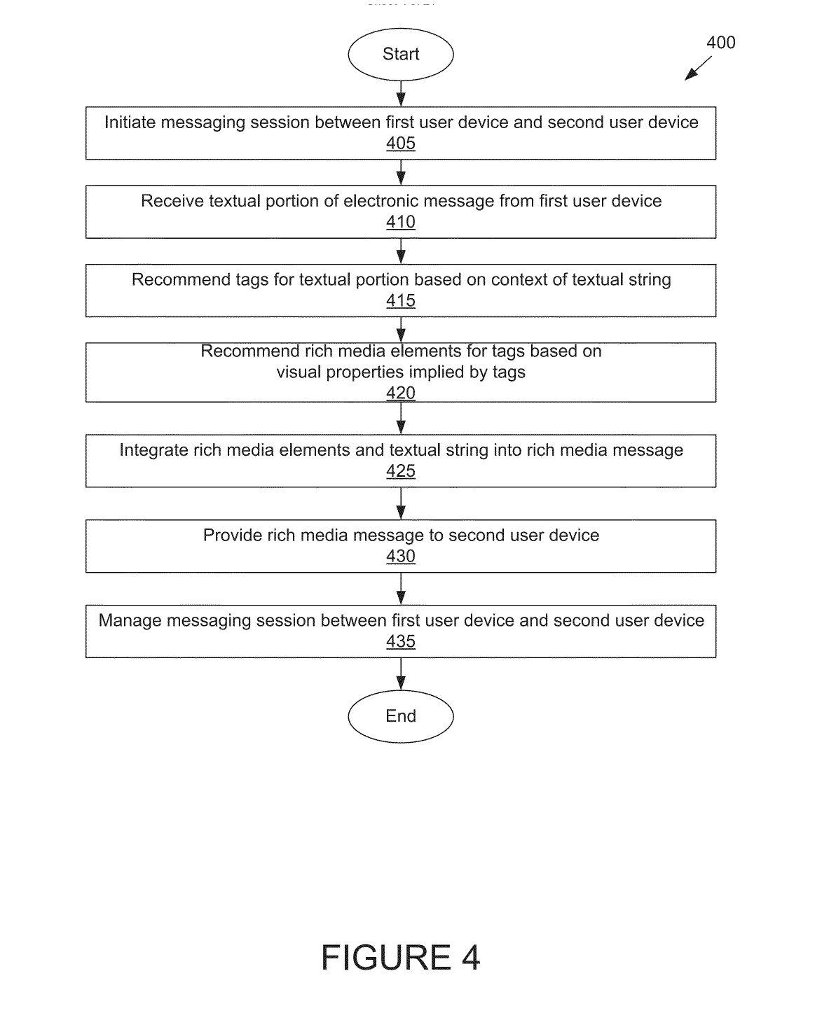

FIG. 4 depicts a flowchart of an example of a method 400 for providing rich media messaging, according to some implementations. The method 400 is discussed in conjunction with the rich media communication engine 125, shown in FIG. 3.

At block 405, the conversation management engine 335 may initiate a messaging session between the first user device 105 and the second user device 110. In a specific implementation, the conversation management engine 335 may receive from the first user device 105 instructions to send a rich media message to the second user device 110. The conversation management engine 335 may ensure that the second rich media application engine 112 is active in the memory of the second user device 110.

At block 410, the first user device interface engine 305 may receive a textual portion of an electronic message from the first user device 105. The first user device interface engine 305 may provide the textual portion of the electronic message to the rich media message management engine 310 for tag recommendations. In a specific implementation, the first user device interface engine 305 may provide the textual portion to the tag recommendation engine 312.

At block 415, the tag recommendation engine 312 may recommend tags for the textual portion, the recommendation being based on a context of the textual portion. In a specific implementation, the tag recommendation engine 312 may attempt to look up whether there are existing tags that are already stored in the tag datastore 314 and that have previously been found to represent the context of the textual portion for the first user. For instance, if the first user were provide the text string “on the road again,” and the tag datastore 314 had an existing tag labeled “Traveling” that corresponded to the text string for the first user, the tag recommendation engine 312 may retrieve the tag “Traveling” from the tag datastore 314 and may recommend the stored tag “Traveling.”

In various implementations, the tag recommendation engine 312 may recommend new tags, that is, tags that have not been previously used for the textual portion from the first user. The new tags may be based on the language structure of the textual portion, the relationship of the textual portion to the first user's geolocational information, the relationship of the textual portion to the first user's prior checkin history, the relationship of the textual portion to the first user's social data, and other contextual information. FIG. 6A depicts a flowchart of recommending tags, that in some implementations, the tag recommendation engine 312 may perform. In various implementations, after block 415, the recommended tags may be sent to the first user device 105 for approval. Approved tags may return to the rich media communication engine 125.

At block 420, the rich media element recommendation engine 316 may recommend rich media elements for the tags, the recommendation being based on the visual properties implied by the tags. In a specific implementation, the rich media element recommendation engine 316 may attempt to look up whether there are existing rich media elements that are already stored in the rich media element datastore 318 and that have previously been found to represent the tags for the first user. For instance, if a tag stating “Traveling” were previously found to correspond to a picture of an airport, the rich media recommendation may retrieve the image of the airport from the rich media element datastore 318 and may recommend the image of the airport to represent the tag.

In some implementations, the rich media element recommendation engine 316 may recommend new rich media elements, that is, rich media elements that have not previously been used for the tags for the first user. The rich media element recommendation engine 316 may evaluate whether the visual properties of rich media elements likely correspond to the subject matter of the tags. In various implementations, the rich media element recommendation engine 316 may request that an artist render rich media elements for tags that have never been rendered. FIG. 8 depicts a flowchart of recommending rich media elements, that in some implementations, the rich media element recommendation engine 316 may perform. In various implementations, after block 420, the recommended rich media elements may be sent to the first user device 105 for approval. Approved rich media elements may return to the rich media communication engine 125.

At block 425, the rich media message creation engine 320 may integrate the rich media elements and the textual string into a rich media message. To weave the rich media elements and the textual string, the rich media message creation engine 320 may determine particular rich media elements that correspond to particular portions of a rich media message. For instance, the rich media message creation engine 320 may identify that a first rich media element corresponds to a background of a rich media message while a second rich media element corresponds to a representation of the first user in the rich media message. The rich media message creation engine 320 may place the textual string and rich media elements into the rich media message to adequately convey the context and meaning of the textual string of the electronic message.

At block 430, the second user device interface engine 325 may provide the rich media message to the second user device 110. In various implementations, the second user device interface engine 325 may provide instructions to display the rich media message in the second rich media application engine 140.

At block 435, the conversation management engine 335 may manage a messaging session between the first rich media application engine 107 and the second rich media application engine 112. Managing a messaging session may involve providing indicators that a user is typing, status indicators, alert messages, etc.

FIG. 5 depicts an example of a tag recommendation engine 312, according to some implementations. As discussed, the tag recommendation engine 312 may provide tag recommendations for textual strings. The tag recommendation engine 312 may include a communication engine 505, a language processing engine 510, a location processing engine 515, a history processing engine 520, a social relationship processing engine 525, an other relationship processing engine 530, and a tag management engine 535.

The communication engine 505 may receive a textual portion of an electronic message from the first user device interface engine 305 (shown in FIG. 3). The communication engine 505 may receive recommended tags from the tag management engine 535. The communication engine 505 may also provide the recommended tags to the first user device interface engine 305.

The language processing engine 510 may receive a textual portion of an electronic message from the communication engine 505. The language processing engine 510 may include one or more language processing engines that identify language characteristics of text provided to it. In various implementations, the language processing engine 510 may include natural language processing (NLP) engines that identify syntactic elements and other parts of speech in the text provided to it. Identified language characteristics may be correlated with the textual portion to determine the context of the textual portions. The language processing engine 510 may identify contextual elements of the text provided to it. The language processing engine 510 may provide identified contextual elements to the tag management engine 535 for tag creation and management.

The location processing engine 515 may receive a textual portion of an electronic message from the communication engine 505. The location processing engine 515 may obtain the first user's location from one or more geography-based transmitters. In various implementations, the location processing engine 515 may obtain the first user's location based on a GPS transmitter on the first user device 105. The location processing engine 515 may also obtain the first user's location based on a wireless triangulation system and/or indoor positioning systems associated with the first user device 105. The location processing engine 515 may correlate the extent the first user's locational information correlates with the textual portion. Using these and other correlations, the location processing engine 515 may determine the context of the textual portions. The location processing engine 515 may provide identified contextual elements to the tag management engine 535 for tag creation and management.

The history processing engine 520 may receive a textual portion of an electronic message from the communication engine 505. The history processing engine 520 may obtain the first user's history of checkins from a social networking system, such as Facebook®. In various implementations, the history processing engine 520 may call APIs on the social networking system to obtain the locations and the circumstances of the first user's past checkins. The history processing engine 520 may correlate the extent the first user's checkins correlate with the textual portion. Using these and other correlations, the location processing engine 515 may determine contextual elements associated with the textual portions. The history processing engine 520 may provide identified contextual elements to the tag management engine 535 for tag creation and management.

The social relationship processing engine 525 may receive a textual portion of an electronic message from the communication engine 505. The social relationship processing engine 525 may obtain the first user's social data from a social networking system, such as Facebook®. Social data may include, for instance, the first user's friends, friendship statuses, other statuses, relationships with objects in a graphical model of the social networking system, and other data. In various implementations, the social relationship processing engine 525 may call APIs on the social networking system to obtain the user's social data. The social relationship processing engine 525 may correlate the extent the first user's social data correlate with the textual portion. Using these and other correlations, the social relationship processing engine 525 may determine contextual elements associated with the textual portions. The social relationship processing engine 525 may provide identified contextual elements to the tag management engine 535 for tag creation and management.

The other relationship processing engine 530 may receive a textual portion of an electronic message from the communication engine 505. The other relationship processing engine 530 may determine contextual elements using other techniques not explicitly discussed herein. The other relationship processing engine 530 may provide identified contextual elements to the tag management engine 535 for tag creation and management.

The tag management engine 535 may create and manage contextual tags. The tag management engine 535 may receive contextual elements from one or more of the communication engine 505, the language processing engine 510, the location processing engine 515, the history processing engine 520, the social relationship processing engine 525, and the other relationship processing engine 530. The tag management engine 535 may create recommended tags based on provided contextual elements. The tag management engine 535 may also retrieve and/or store tags in the tag datastore 314.

FIG. 6A depicts a flowchart of an example of a method 600A for recommending contextual tags for an electronic message, according to some implementations. The method 600A is discussed in conjunction with the tag recommendation engine 312 shown in FIG. 5.

At block 605, the communication engine 505 may receive a textual portion of an electronic message. In various implementations, the communication engine 505 may receive the textual portion of the electronic message from the first user device interface engine 305, shown in FIG. 3. The textual portion of the electronic message may correspond to text that the first user is trying to enter in a real media message being composed. In various implementations, the communication engine 505 may provide the textual portion of the electronic message to the tag management engine 535. Control may continue to decision point 610.

At decision point 610, the tag management engine 535 may determine whether there is an existing tag that represents the context of the textual portion. In various implementations, the tag management engine 535 may search the tag datastore 314 for tags that represent the textual portion. More specifically, the tag management engine 535 may query the tag datastore 314 for tags of a particular context. If an existing tag in the tag datastore 314 represents the context of the textual portion, the method 600A may proceed to block 615. If no existing tag in the tag datastore 314 represents the context of the textual portion, the method 600A may proceed to block 620.

At block 615, the tag management engine 535 may retrieve the stored contextual tag. In various implementations, the tag management engine 535 may retrieve the tags that are for the particular context requested by the tag management engine 535. In some implementations, the tag management engine 535 may implement the method 600B, shown in FIG. 6B. More specifically, in various implementations, the tag management engine 535 may provide a ranked list of contextual tags, where the ranking is associated with how relevant contextual tags are to the textual portion, the context of the textual portion, or the first user. As such, the tag management engine 535 may adaptively choose the best set of contextual tags for the first user based on the first user's prior tagging history. The resulting ranked list of contextual tags may allow the system to be weighted toward providing the most relevant contextual tag (and rich media elements) for a given textual portion from the first user. The tag management engine 535 may provide the contextual tag to the communication engine 505.

At block 620, the language processing engine 510 may identify contextual elements of the textual portion based on language characteristics of the textual portion. In various implementations, the language processing engine 510 may perform natural language processing of the textual portion. More specifically, the language processing engine 510 may identify syntactic elements and other parts of speech in the textual portion. In a specific implementation, the language processing engine 510 may identify subjects, objects, direct objects, other nouns, verbs, adjectives, adverbs, and other syntactic elements and parts of speech in the textual portion.

Once the language processing engine 510 has identified syntactic elements and parts of speech in the textual portion, the language processing engine 510 may infer context from the identified syntactic elements and parts of speech. As an example, if the language processing engine 510 were provided with the phrase “on the road again,” the language processing engine 510 may identify the subject as the writer (e.g., the first user). The language processing engine 510 may further identify the object of the phrase as the “road.” As a verb is absent from the phrase, the language processing engine 510 may infer that a conjugate of the verb “be” is to be present in the phrase. The language processing engine 510 may further infer that the subject (i.e., the first user) is to “be” “on the road.” In accordance with this interpretation, the language processing engine 510 may identify contextual elements related to traveling, cars, or moving.

In various implementations, the language processing engine 510 may infer emotions that the syntactic elements and parts of speech signify. For example, the language processing engine 510 may infer that the phrase “on the road again” corresponds to emotions of hope and enthusiasm. The language processing 510 may provide such terms for contextual tag recommendations. In some implementations, the language processing engine 510 may infer background from the syntactic elements and parts of speech. For example, the language processing engine 510 may infer that the phrase “on the road again” is to be linked with a particular background associated with traveling.

At block 625, the location processing engine 515 may identify contextual elements of the textual portion based on the first user's location. The location processing engine 515 may obtain the first user's location using a geography-based transmitter, wireless network triangulation techniques, indoor positioning techniques, or other techniques. The location processing engine 515 may also analyze whether the textual portion can be correlated with the first user's locational information. For example, if the textual portion contained the text “getting coffee,” and the first user's location indicated that the first user were at a particular block of Geary Boulevard in San Francisco, the location processing engine 515 may infer that the locational context of the phrase, “getting coffee” would be at a coffee shop on that particular block of Geary Boulevard in San Francisco. The location processing engine 515 may provide the identified contextual elements to the tag management engine 535 to create tags based on the identified contextual elements.

At block 630, the history processing engine 520 may identify contextual elements of the textual portion based on the first user's checkin history. In various implementations, the history processing engine 520 may obtain from a third party social networking system the history of the first user's checkins Based on that history, the history processing engine 520 may analyze whether the textual portion can be correlated with the first user's checkin history. To continue the foregoing example, if the textual portion contained the text “getting coffee,” and the first user's checkin status indicated that the first user was had previously checked into a coffee shop at a particular block of Geary Boulevard in San Francisco on Facebook®, the history processing engine 520 may infer that the phrase “getting coffee” would be at that coffee shop. Or, the history processing engine 520 may determine with whom the first user has checked into that particular coffee shop. If another user is correlated with the first user's checkin history, the history processing engine 520 may provide the identity of the other person as a contextual element to the provided phrase. The history processing engine 520 may provide the identified contextual elements to the tag management engine 535 to create tags based on the identified contextual elements.

At block 635, the social relationship processing engine 525 may identify contextual elements based on the user's social data. In various implementations, the social relationship processing engine 525 may obtain from a third party social networking system the first user's social relationship data. In various implementations, the social relationship processing engine 525 may obtain the first user's friends, friendship statuses, other statuses, items that the first user or friends of the first user tagged, locational tags associated with the first user or the first user's friends, relationships with objects in a graphical model of the social networking system, and other data. To again continue the foregoing example, if the textual portion contained the text “getting coffee,” and the user's social data indicated that the first user had liked a particular coffee shop and was with several friends at that coffee shop several times, the social relationship processing engine 525 may infer that the phrase “getting coffee” would be at that coffee shop. The social relationship processing engine 525 may provide the identified contextual elements to the tag management engine 535 to create tags based on the identified contextual elements.

At block 640, the other relationship processing engine 530 may identify contextual elements based on other information. The other relationship processing engine 530 may provide the identified contextual elements to the tag management engine 535 to create tags based on the identified contextual elements.

At block 645, the tag management engine 535 may create a contextual tag based on the identified contextual element(s). The tag management engine 535 may analyze the relationships that have been identified by the language processing engine 510, the location processing engine 515, the history processing engine 520, the social relationship processing engine 525, the other relationship processing engine 530, or some combination thereof. Based on this analysis, the tag management engine 535 creates a contextual tag for the textual portion of the electronic message. The tag management engine 535 may provide the contextual tag to the communication engine 505.

At block 650, the communication engine 505 may provide the contextual tag. In various implementations, the communication engine 505 may provide the contextual tag to the first user device 105 for approval. In other embodiments, the communication engine 505 may provide the contextual tag to other modules, such as the second user device 110 and/or the content system(s) 120. As discussed herein, the provided contextual tag may comprise a tag recommendation for the textual portion of the electronic message.

FIG. 6B depicts a flowchart of an example of a method 600B for retrieving a stored contextual tag for an electronic message, according to some implementations. The method 600B is discussed in conjunction with the tag management engine 535, shown in FIG. 5.

At block 615A, the tag management engine 535 may obtain the first user's contextual tag history. In some implementations, the tag management engine 535 may query the tag datastore 314 for all contextual tags associated with the first user. It is noted that the tag management engine 535 may also limit the query in various ways. For instance, the tag management engine 535 may query the tag datastore 314 for contextual tags that are associated with the textual portion. The result of the query is a set of contextual tags for the first user that are returned to the tag management engine 535.

At block 615B, the tag management engine 535 may determine a set of contextual tags that have been applied to a similar context as the context of the textual portion. In some implementations, the tag management engine 535 may determine a set of contextual tags the first user has previously tagged a similar textual portion with. That is, the tag management engine 535 may compare the textual portion to a history of other textual portions the first user has previously sought to contextually tag. To the extent that the textual portion is similar to the other textual portions, the tag management engine 535 may associate similar contextual tags.

In various implementations, the tag management engine 535 may find determine a set of contextual tags based on the last contextual tag the first user applied to the textual portion. For example, if the first user selected the contextual tag “listening” as the last tag for the textual portion, the tag management engine 535 may adaptively infer that a set of contextual tags for popular bands (e.g., the “Beetles”, etc.) should be provided. If the first user selected the band the “Beetles” as the last tag for the textual portion, the tag management engine 535 may adaptively infer that a set of contextual tags for popular songs by the Beetles (e.g., a “Hard Day's Night”, etc.) should be provided.

At block 615C, the tag management engine 535 may rank the list of contextual tags in terms of their relevance to the textual portion, to the context of the textual portion, or to the user. In various implementations, the tag management engine 535 may determine that a particular set of tags are more relevant to the textual portion than others. The more relevant tags may be provided as a ranked list of contextual tags in block 615D.

FIG. 7 depicts an example of a rich media element recommendation engine 316, according to some implementations. As discussed, the rich media element recommendation engine 316 may provide rich media element recommendations for contextual tags. The rich media element recommendation engine 316 may comprise a communication engine 705, a rich media element lookup engine 710, a rendition request engine 715, and a rich media element management engine 720.

The communication engine 705 may receive a contextual tag from the first user device interface engine 305 (shown in FIG. 3). The communication engine 705 may receive recommended rich media elements from the rich media element management engine 720. The communication engine 705 may also provide the recommended rich media elements to the first user device interface engine 305.

The rich media element lookup engine 710 may provide the rich media element management engine 720 with instructions to lookup rich media elements in the rich media element datastore 318 for a particular contextual tag. The rendition request engine 715 may request from the rich media rendition engine 130 (shown in FIG. 1) rendition of rich media elements for contextual tags for which there are no stored rich media elements.

The rich media element management engine 720 may retrieve, store, and query rich media elements from the rich media element datastore 318. In various implementations, the rich media element management engine 720 may execute queries that determine whether the rich media element datastore 318 contains a rich media element for a particular contextual tag. The rich media element management engine 720 may also store new rich media element in the rich media element datastore 318 and may obtain existing rich media elements from the rich media element datastore 318.

FIG. 8 depicts a flowchart of an example of a method 800 for recommending rich media elements for electronic messages, according to some implementations. The method 800 is discussed in conjunction with the rich media element recommendation engine 316, shown in FIG. 7.

At block 805, the communication engine 705 may receive a contextual tag that represents a textual portion of an electronic message. In various implementations, the communication engine 705 may receive, from the first user device interface engine 305 (shown in FIG. 3) an approved contextual tag for a part of an electronic message. The contextual may correspond to text that the first user is trying to enter in a real media message being composed. For example, the communication engine 705 may receive the contextual tag “Traveling” from the first user device interface engine 305. The tag “Traveling” may be taken to provide a context of a textual portion of an electronic message the first user is composing. In various implementations, the communication engine 705 may provide the contextual tag to the rich media element lookup engine 710.

At block 810, the rich media element lookup engine 710 may look up a rich media element, the lookup being based on the contextual tag. In some implementations, the rich media element lookup engine 710 may provide instructions to the rich media element management engine 720 to query the rich media element datastore 318 for rich media elements that match the provided contextual tag. To continue the foregoing example, the rich media element lookup engine 710 may look up rich media elements that correspond to the contextual tag “Traveling.” Control may proceed to decision point 815.

At decision point 815, the rich media element management engine 720 may determine whether the contextual tag corresponds to an existing rich media element that is stored in the rich media element datastore 318. If the contextual tag corresponds to an existing rich media element that is stored in the rich media element datastore 318, the method 800 may proceed to block 820. At block 820, the rich media element management engine 720 may retrieve from the rich media element datastore 318 a stored rich media element to represent the context of the textual portion. To again continue the foregoing example, the rich media element management engine 720 may retrieve rich media elements (e.g., renditions of an airport) that correspond to the tag “Traveling.”

If the contextual tag does not correspond to an existing rich media element that is stored in the rich media element datastore 318, the method 800 may proceed to block 825. At block 825, the rendition request engine 715 may send the contextual tag to the rich media rendition engine 130 (shown in FIG. 1) for rendering of a rich media element that corresponds to the contextual tag. As an example, suppose the contextual tag “Trees” did not have a rich media element associated with it for the first user. Then, the rendition request engine 715 may request the rich media rendition engine 130 to provide a rich media element that renders the context “Trees.” At block 830, the rendition request engine 715 may receive a rendered rich media element from the rich media rendition engine 130. At block 835, the communication engine 705 may provide the rich media element for integration into a rich media message.

FIG. 9 shows an example of a digital device 300. In the example of FIG. 9, the digital device 300 can be a conventional computer system that can be used as a client computer system, such as a wireless client or a workstation, or a server computer system. The digital device 300 includes a computer 905, I/O devices 910, and a display device 915. The computer 905 includes a processor 920, a communications interface 925, memory 930, display controller 935, non-volatile storage 940, and I/O controller 945. The computer 905 can be coupled to or include the I/O devices 910 and display device 915.

The computer 905 interfaces to external systems through the communications interface 925, which can include a modem or network interface. It will be appreciated that the communications interface 925 can be considered to be part of the digital device 300 or a part of the computer 905. The communications interface 925 can be an analog modem, ISDN modem, cable modem, token ring interface, satellite transmission interface (e.g. “direct PC”), or other interfaces for coupling a computer system to other computer systems.

The processor 920 can be, for example, a conventional microprocessor such as an Intel Pentium microprocessor or Motorola power PC microprocessor. The memory 930 is coupled to the processor 920 by a bus 950. The memory 930 can be Dynamic Random Access Memory (DRAM) and can also include Static RAM (SRAM). The bus 950 couples the processor 920 to the memory 930, also to the non-volatile storage 940, to the display controller 935, and to the I/O controller 945.

The I/O devices 910 can include a keyboard, disk drives, printers, a scanner, and other input and output devices, including a mouse or other pointing device. The display controller 935 can control in the conventional manner a display on the display device 915, which can be, for example, a cathode ray tube (CRT) or liquid crystal display (LCD). The display controller 935 and the I/O controller 945 can be implemented with conventional well known technology.

The non-volatile storage 940 is often a magnetic hard disk, an optical disk, or another form of storage for large amounts of data. Some of this data is often written, by a direct memory access process, into memory 930 during execution of software in the computer 905. One of skill in the art will immediately recognize that the terms “machine-readable medium” or “computer-readable medium” includes any type of storage device that is accessible by the processor 920 and also encompasses a carrier wave that encodes a data signal.

The digital device 300 is one example of many possible computer systems which have different architectures. For example, personal computers based on an Intel microprocessor often have multiple buses, one of which can be an I/O bus for the peripherals and one that directly connects the processor 920 and the memory 930 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 930 for execution by the processor 920. A Web TV system, which is known in the art, is also considered to be a computer system, but it can lack some of the features shown in FIG. 9, such as certain input or output devices. A typical computer system will usually include at least a processor, memory, and a bus coupling the memory to the processor.

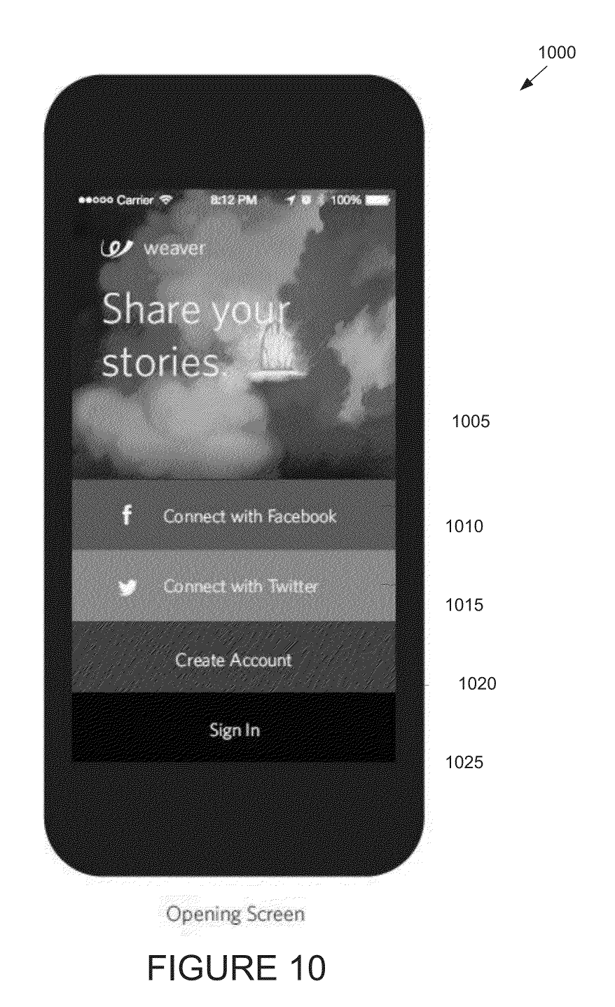

FIG. 10 depicts a preview of an opening screen 1000 of a rich media messaging application, according to some implementations. The opening screen 1000 may include an introductory screen 1005, a first social networking login button 1010, a second social networking login button 1015, an account creation button 1020, and a sign in button 1025.

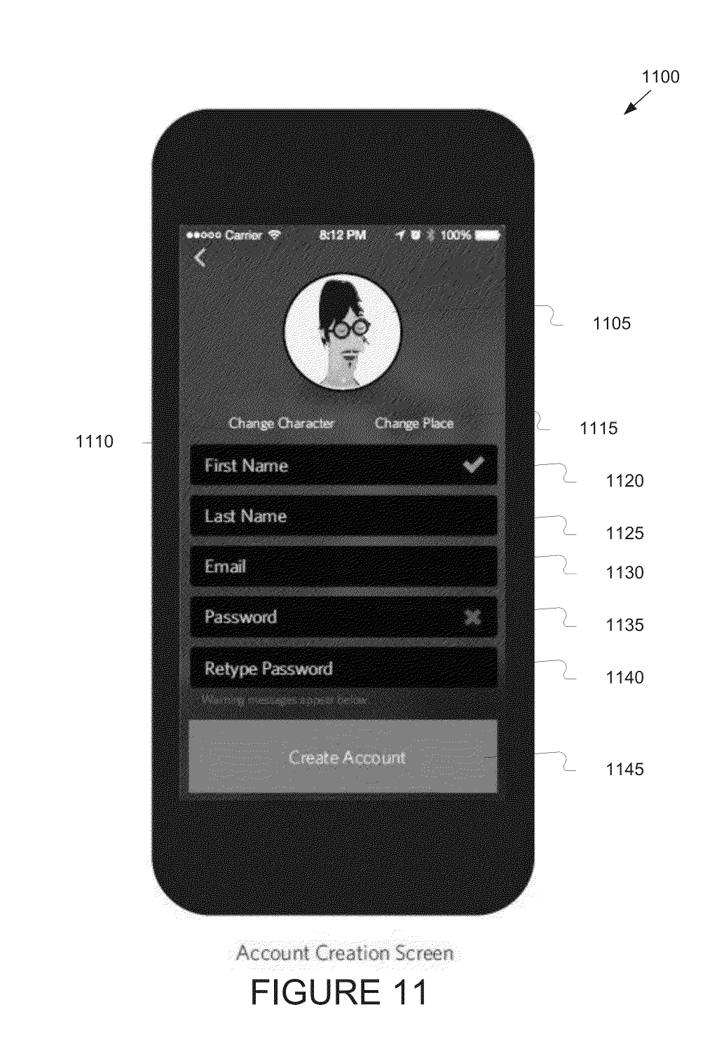

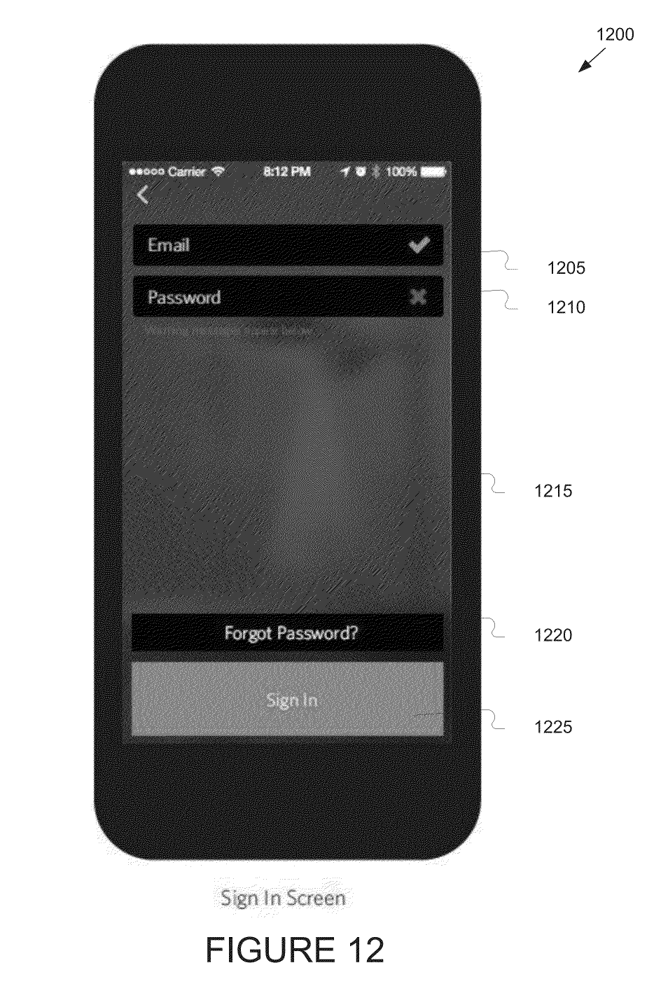

The introductory screen 1005 may provide a user with a title of the rich media messaging application. The first social networking login button 1010 may allow the user to access the rich media messaging application with the user's credentials for a first social networking system, here Facebook®. The second social networking login button 1015 may allow the user to access the rich media messaging application with the user's credentials for a second social networking system, here the blogging system Twitter®. The credentials for the second social networking system may be different from the credentials for the first social networking system. The account creation button 1020 may link the user to an account creation screen, an example of which is shown in FIG. 11. The sign in button 1025 may link the user to a sign in screen, an example of which is shown in FIG. 12.

FIG. 11 depicts a preview of an account creation screen 1100 of the first rich media application engine 107, according to some implementations. The account creation screen 1100 may provide information so that the rich media account management engine 330 inside the first rich media application engine 107 may create a user account. A user may have navigated to the account creation screen 1100 after the user selected the account creation button 1020 shown in FIG. 10. The account creation screen 1100 may include a personal image icon 1105, a change character button 1110, a change location button 1115, a first name field 1120, a last name field 1125, a username field 1130, a first password field 1135, a second password field 1140, and a create account button 1145.

The personal image icon 1105 may provide a depiction of the user's appearance in rich media messages in the rich media messaging system 100. Rich media messages having the user as a subject or object may represent the user with the image associated with the personal image icon 1105. That is, image associated with the personal image icon 1105 may form the basis of the user's avatar in rich media messages. The personal image icon 1105 may include an image, such as a drawing, a photo, a caricature, a meme, or other icon. The image may be similar to the user's appearance in a real or a virtual world. The image may have been customized for the user. The image may have been purchased from the application store engine(s) 145 or obtained from one or more of the content engine(s) 120.

The change character button 1110 may allow the user to change the image used for the personal image icon 1105. In various implementations, the change character button 1110 may link the user to image sources that can be used for the user's personal character icon. For instance, the change character button 1110 may link the user to a camera of the first user device 105 so that the associated with the personal image icon 1105 may be captured. As another example, the change character button 1110 may link the user to the file system of the first user device 105 so that a file stored on the first user device 105 may be uploaded. As yet another example, the change character button 1110 may link the user to a file in one of the content engine(s) 120 so that a file on one of the content engine(s) 120 may be accessed. As yet another example, the change character button 1110 may link the user to the application store engine(s) 145 or one or more of the content engine(s) 120 so that a file on the application store engine(s) 145 and/or content engine(s) 120 may be accessed. The new image may replace the old image for the personal image icon 1105.

The change location button 1115 may allow the user to change the user's location for rich media messaging. As discussed, rich media messages incorporating the user may represent the user's location as rich media elements. A graphical depiction of the user's location may form at least a part of the rich media messaging. In various implementations, the change location button 1115 may link the user to location sources that form the basis of the user's location. As an example, the change location button 1115 may provide a link to geographical locational services, including geography based services, such as a Global Positioning System (GPS). As another example, the change location button 1115 may link the user to a screen that allows the user to enter location manually. As yet another example, the change location button 1115 may link the user to triangulated wireless locational systems, indoor positioning systems, or other systems that provide the user's location for rich media messaging. Such a location may prove useful to the location processing engine 515 (shown in FIG. 5).

The first name field 1120 may receive the user's first name. The last name field 1125 may receive the user's last name. The username field 1130 may allow the user to enter a username, here the user's email address. In various implementations, the rich media account management engine 330 may require that the entered username is unique to the system implemented by the rich media account management engine 330. In some implementations, where an email address is provided as the username, the rich media account management engine 330 may send a confirmatory email to the provided email address to ensure the user is legitimate.

The first password field 1135 may allow the user to enter a password, and the second password field 1140 may allow the user to confirm the entered password. The create account button 1145 may provide the information in the account creation screen 1100 to the rich media account management engine 330 so that a new account can be created. Once the create account button 1145 is selected, the rich media account management engine 330 may guide the user to the sign in screen 1200 shown in FIG. 12.

FIG. 12 depicts a preview of a sign in screen 1200 of the first rich media application engine 107, according to some implementations. The sign in screen 1200 may provide information so that the rich media account management engine 330 inside the first rich media application engine 107 may authenticate credentials for a user account. A user may have navigated to the sign in screen 1200 by selecting the sign in button 1025, shown in FIG. 10, and/or the create account button 1145, shown in FIG. 11. The sign in screen 1200 may include a username field 1205, a password field 1210, a warning box 1215, a forgot password button 1220, and a sign in button 1225.

The username field 1205 may receive a username for the rich media account management engine 330. In the example of FIG. 12, the username may include the email address of a user trying to be authenticated to the rich media account management engine 330. The password field 1210 may receive a password associated with a username to be authenticated. The warning box 1215 may display any warnings associated with the authentication process. The forgot password button 1220 may provide a link to a password recovery screen. The sign in button 1225 may provide the username and the password that was provided to the rich media account management engine 330.

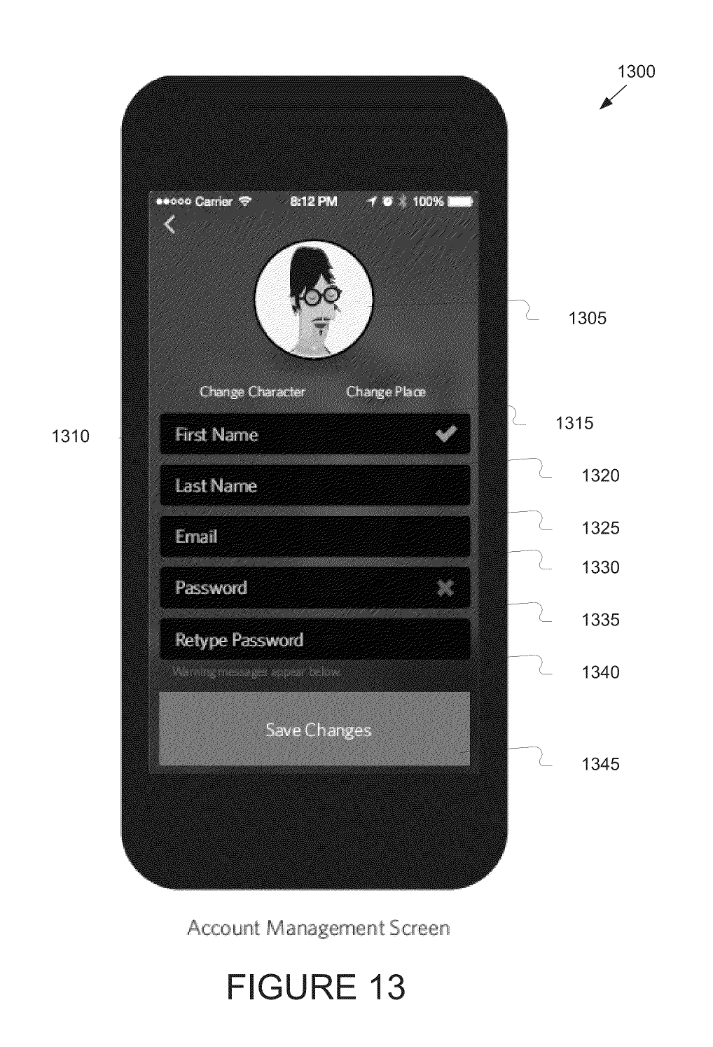

FIG. 13 depicts a preview of an account management screen 1300 of a first rich media application engine 107, according to some implementations. The account management screen 1300 may provide information so that the rich media account management engine 330 inside the first rich media application engine 107 may manage credentials for a user account. The user may have navigated to the account management screen 1300 after the user has signed in with the sign in screen 1200, shown in FIG. 12, to rich media messaging services.

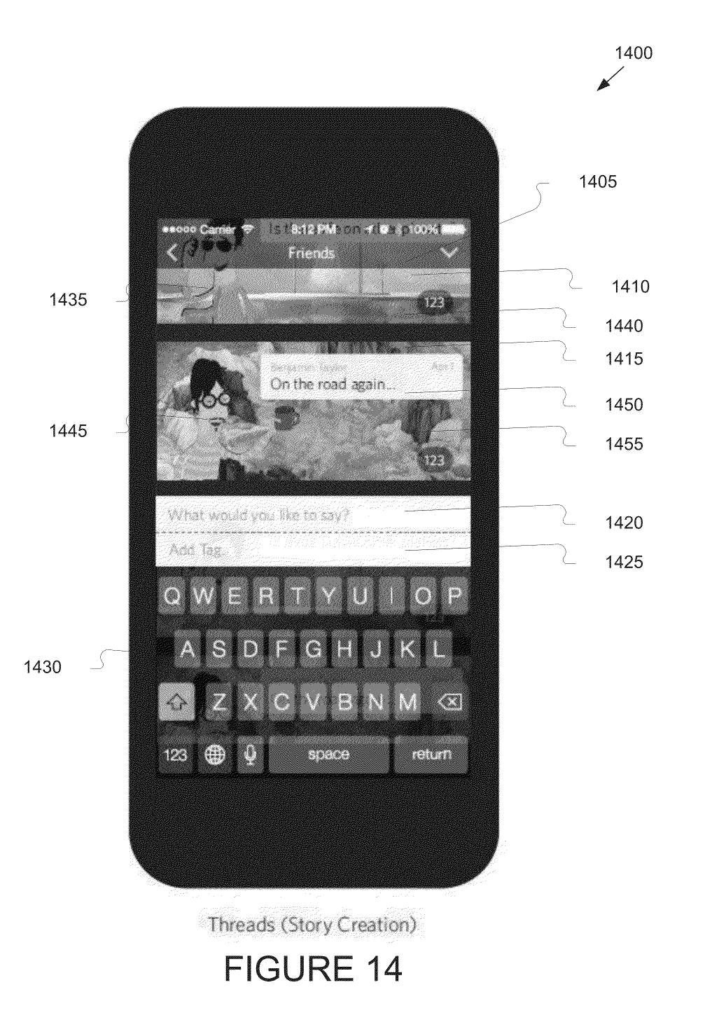

The account management screen 1300 may include a personal image icon 1305, a change character button 1310, a change location button 1315, a first name field 1320, a last name field 1325, a username field 1330, a first password field 1335, a second password field 1340, and a save changes button 1345. One or more of the personal image icon 1305, the change character button 1310, the change location button 1315, the first name field 1320, the last name field 1325, the username field 1330, the first password field 1335, and the second password field 1340 may operate similarly to its counterparts in FIG. 11. The save changes button 1345 may provide the information entered into the account management screen 1300 so that the rich media account management engine 330 may manage the user account. In various implementations, selecting the save changes button 1345 may link the user to a story creation screen, such as the story creation screen 1400 shown in FIG. 14.

FIG. 14 depicts a preview of a story creation screen 1400 of the first rich media application engine 107, according to some implementations. The story creation screen 1400 may allow the first rich media application engine 107 to provide rich media messages to the second rich media application engine 112. In various implementations, the rich media message management engine 310 may provide the story creation screen 1400 after the user's credentials have been authenticated by the rich media account management engine 330. The story creation screen 1400 may include a friend link 1405, a first rich media message 1410, a second rich media message 1415, a text entry field 1420, a tag entry field 1425, and a keyboard 1430.

The friend link 1405 may provide a list of friends for the first rich media application engine 107. In various implementations, sliding the friend link 1405 down may provide the list of friends of the user. The rich media message management engine 310 may populate the list of friends with the user's connections. In some implementations, the list of friends may be imported from external social networking systems or external address books that are different from rich media messaging providers. The list of friends may include the user of the second rich media application engine 112, shown in FIG. 1, as well as other users in various implementations.

The first rich media message 1410 may include rich media content from the user of the first rich media application engine 107. The first rich media message 1410 may include a personal character icon 1435 and a background image 1440. The personal character icon 1435 may represent how the user of the first rich media application engine 107 appears as a character in the first rich media message 1410. The background image 1440 may represent the environment of the user of the first rich media application engine 107 in the first rich media message 1410. One or more of the personal character icon 1435 and the background image 1440 may have been provided by the rich media creation engine 345. In this example, the background image 1440 may provide an environment for the first rich media message 1410 while the personal character icon 1435 may provide a subject for any actions that are attributed to the user from the text associated with the first rich media message 1410.

The second rich media message 1415 may include rich media content from the user of the second rich media application engine 112. In this example, the second rich media message 1415 may include a personal character icon 1445, a text display area 1450, and a background image 1455. The personal character icon 1445 may represent how the user of the second rich media application engine 112 appears as a character in the second rich media message 1415. The text display area 1450 may display text associated with the second rich media message 1415, including, for instance, text that the user has entered for the second rich media message 1415. The background image 1455 may represent the environment of the user of the second rich media application engine 112 in the second rich media message 1415. One or more of the personal character icon 1445 and the background image 1455 may have been provided by a rich media creation engine that is associated with the second rich media application engine 112. In this example, the background image 1455 may provide an environment for the second rich media message 1415 while the personal character icon 1445 may provide a subject for any actions that are attributed to the user from the text associated with the second rich media message 1415.

The text entry field 1420 may provide text for rich media messages, such as messages for the user of the first rich media application engine 107. The text entry field 1420 may receive textual input from the keyboard 1430. The text entry field 1420 may have provided text for the first rich media message 1410. In various embodiments, the textual portion of the electronic message may be provided into the text entry field 1420.

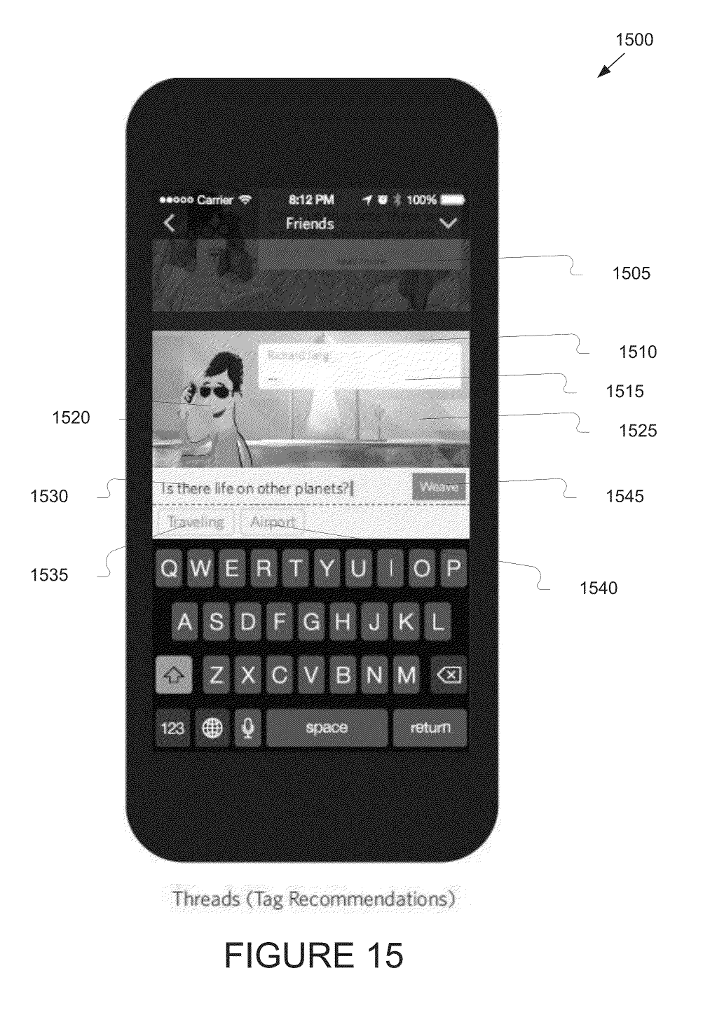

The tag entry field 1425 may provide tags for rich media messages, such as the messages for the user of the first rich media application engine 107. In various implementations, the tag entry field 1425 is populated with contextual tags recommendations as the user enters text into the text entry field 1420. The tag entry field 1425 may also be populated with contextual tags after the user enters text into the text entry field 1420. The tag entry field 1425 may receive contextual tags from the tag recommendation engine 312, shown in FIG. 3. FIG. 15 further shows how the tag entry field 1425 is populated with contextual tag recommendations.

The keyboard 1430 may allow the user of the first rich media application engine 107 to enter text for rich media messages, such as messages for the user of the first rich media application engine 107. Text entered into the keyboard 1430 may be provided to the text entry field 1420.

FIG. 15 depicts a preview of a story creation screen 1500 of the first rich media application engine 107, according to some implementations. In the story creation screen 1500, the tag recommendation engine 312 has provided contextual tag recommendations for text. The story creation screen 1500 may include a second rich media message 1505 and a third rich media message 1510. In this example, the second rich media message 1505 may correspond to the second rich media message 1415 shown in FIG. 14.

The third rich media message 1510 may include another rich media message from the user who sent the first rich media message 1410, shown in FIG. 14. In this example, the third rich media message 1510 may comprise a text display area 1515, a personal character icon 1520, a background image 1525, a text entry field 1530, a first recommended tag 1535, a second recommended tag 1540, and an integration request button 1545. The text display area 1515 may display text associated with the third rich media message 1510. The personal character icon 1520 may represent, in the third rich media message 1510, how the user visually appears within the third rich media message 1510. The background image 1525 may represent, in the third rich media message 1510, the environment of the user of the first rich media application engine 107.

The text entry field 1530 may provide text for the third rich media message 1510. The text entry field 1530 may receive textual input from the text input box herein. The text entry field 1530 may have provided text for the third rich media message 1510. In this example, the user has entered the language “Is there life on other planets?” into the text entry field 1530. Further in this example, the entered text is converted into tags, which are in turn, converted into rich media, by the engines of the first rich media application engine 107.

The first recommended tag 1535 may comprise a first tag that has been recommended by the tag recommendation engine 312 based on the context of the text in the text entry field 1530 and other contextual factors. Similarly, the second recommended tag 1540 may comprise a second tag that has been recommended by the tag recommendation engine 312 based on the context of the text in the text entry field 1530, and other contextual factors. In this example, the tag recommendation engine 312 has recommended the tags “Traveling” and “Airport.” The tags “Traveling” and “Airport” may correspond to the language “Is there life on other planets?” based on language processing and on other processing of the entered text. Such language processing and other processing may be performed by the engines of the tag recommendation engine 312.

The integration request button 1545 may allow the user to submit the text in the text entry field 1530, selected tags, and other information for integration by the rich media message management engine 310 into the third rich media message 1510. In the example of FIG. 15, the integration request button 1545 has not yet been selected.

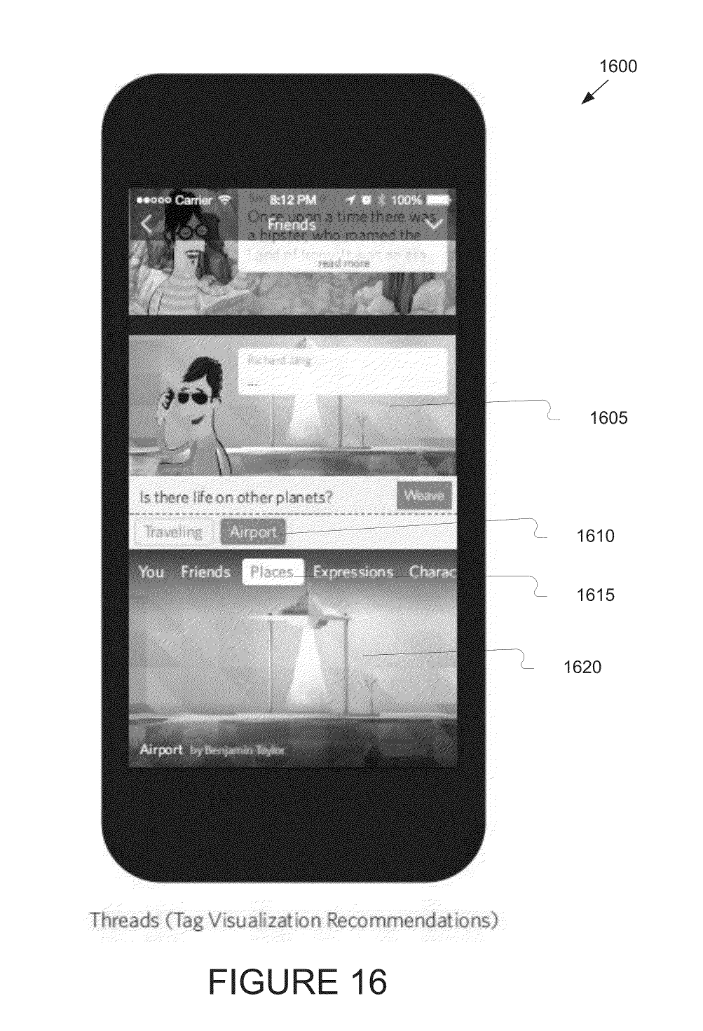

FIG. 16 depicts a preview of a story creation screen 1600 of the first rich media application engine 107, according to some implementations. In the story creation screen 1600, the rich media creation engine 345 has provided rich media element recommendations for a rich media message. The story creation screen 1600 may include a third rich media message 1605, a selected tag 1610, a recommended rich media category 1615, and a recommended rich media item 1620. The third rich media message 1605 may correspond to the third rich media message 1510, shown in FIG. 15.

The selected tag 1610 may include a contextual tag that the user of the first rich media application engine 107 has indicated visually depicts the text of the message that the user has entered. In this example, the selected tag 1610 provides the contextual tag “Airport” to indicate that the word “airport” provides a context to images that visually depict the contents of the message “Is there life on other planets?” The tag may have been recommended by the tag recommendation engine 312. Moreover, in the example of FIG. 16, the recommended rich media category 1615 shows categories of images that correspond to the contents of the entered message. In this example, the user is provided the recommended rich media item 1620, which comprises an image entitled “Airport.” The recommended rich media item 1620 provides a visual backdrop for the entered image. The recommended rich media item 1620 may have been provided by the rich media creation engine 345. As a result, the user of the first rich media application engine 107 is allowed to communicate with pictures by weaving ordinary text into rich media messages that convey the user's message in a visual way.

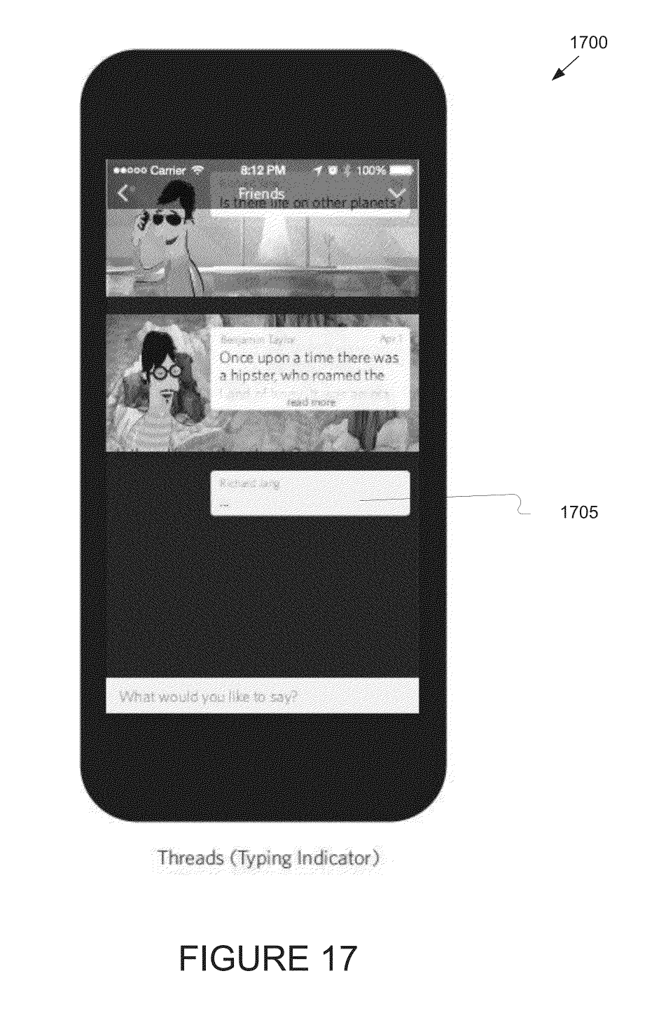

FIG. 17 depicts a preview of a story creation screen 1700 of the first rich media application engine 107, according to some implementations. The story creation screen 1700 may comprise a typing indicator box 1705. The typing indicator box 1705 may show a user of the first rich media application engine 107 that the user of the second rich media application engine 112 is composing a rich media message.

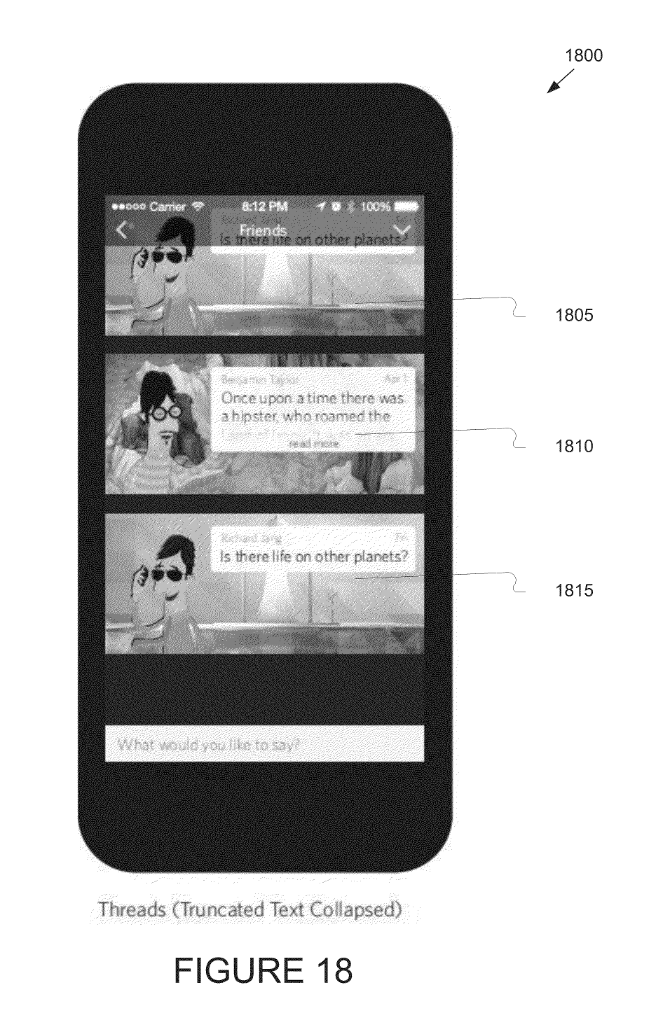

FIG. 18 depicts a preview of a story creation screen 1800 of the first rich media application engine 107, according to some implementations. The story creation screen 1800 may include a truncated view of: a first rich media message 1805, a second rich media message 1810, and a third rich media message 1815. The first rich media message 1805, the second rich media message 1810, and the third rich media message 1815 may have the attributes of rich media messages, as discussed herein. More specifically, the first rich media message 1805, the second rich media message 1810, and the third rich media message 1815 may contain rich media elements that visually depict a message being sent between users of rich media messaging applications. The first rich media message 1805, the second rich media message 1810, and the third rich media message 1815 may also allow users to communicate with one another by weaving ordinary text into rich media messages that convey content and context of communications in a visual manner.

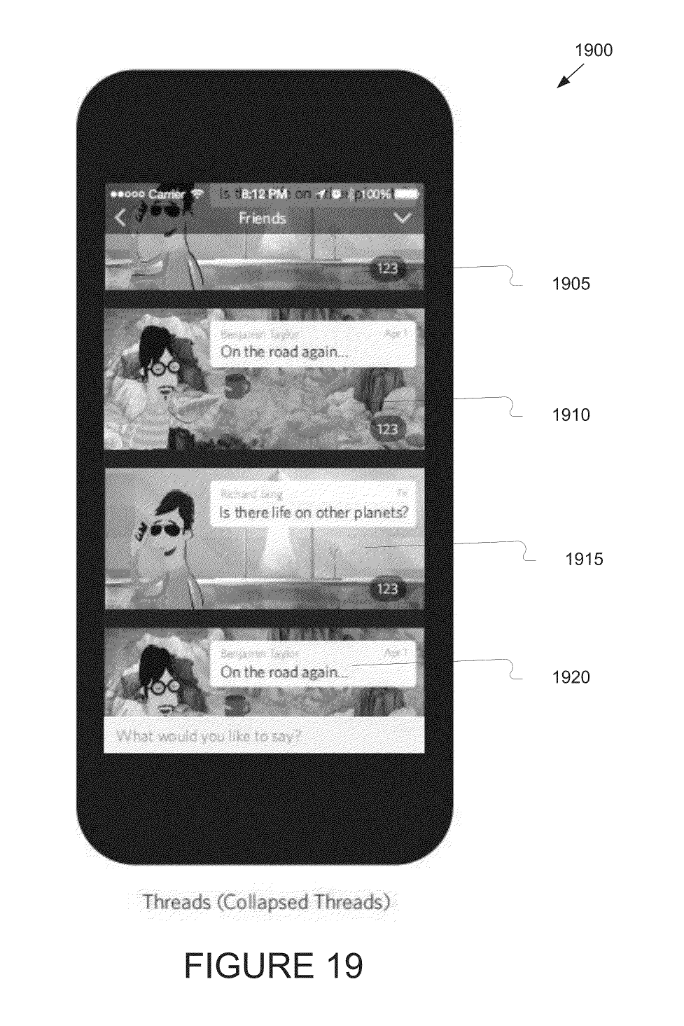

FIG. 19 depicts a preview of a story creation screen 1900, according to some implementations. The story creation screen 1900 may include a collapsed view of: a first rich media message 1905, a second rich media message 1910, a third rich media message 1915, and a fourth rich media message 1920. The first rich media message 1905, the second rich media message 1910, the third rich media message 1915, and the fourth rich media message 1920 may have the attributes of rich media messages, as discussed herein. More specifically, the first rich media message 1905, the second rich media message 1910, the third rich media message 1915, and the fourth rich media message 1920 may contain rich media elements that visually depict a message being sent between users of rich media messaging applications. The first rich media message 1905, the second rich media message 1910, the third rich media message 1915, and the fourth rich media message 1920 may also allow users to communicate with one another by weaving ordinary text into rich media messages that convey content and context of communications in a visual manner.

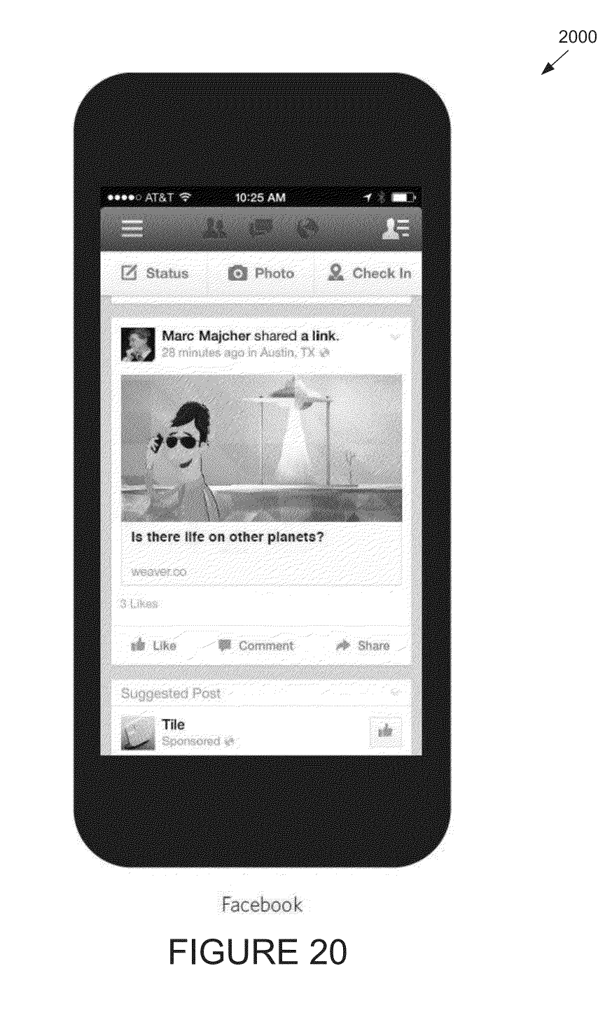

FIG. 20 depicts a preview of a social networking system screen 2000, according to some implementations. The social networking system screen 2000 may include a rich media message 2005. In the example of FIG. 20, the rich media message 2005 has been integrated into a social networking system. More specifically, the social networking system has received the rich media message 2005 and has posted the rich media message 2005 to a wall of a user of the social networking system. In various implementations, the user of the social networking system may correspond to the user of the first rich media application engine 107 (shown in FIG. 1).

Though the discussion related to FIGS. 11-20 discusses the account creation screen 1100, the sign in screen 1200, the account management screen 1300, and the story creation screens 1400-2000 as corresponding to the first rich media application engine 107, it is noted that the account creation screen 1100, the sign in screen 1200, the account management screen 1300, and/or the story creation screens 1400-2000 may also correspond to applications on other devices. More specifically, in various implementations, the account creation screen 1100, the sign in screen 1200, the account management screen 1300, and/or the story creation screens 1400-2000 may correspond to the a screen provided by the second rich media application engine 112 or other rich media messaging applications.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some implementations”, “various implementations”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some implementations, but also variously omitted in other embodiments. Similarly, various features are described that may be preferences or requirements for some implementations, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the claims recited herein.

What is claimed is:

1. A method comprising:
receiving a textual portion of an electronic message from a first user device to a second user device;
recommending one or more contextual tags to represent a context of the textual portion, the recommending the one or more contextual tags based at least in part on the receiving the textual portion;
recommending one or more rich media elements to represent the context of the textual portion, the recommending the one or more rich media elements based at least in part on the one or more contextual tags;
integrating the one or more rich media elements and the textual portion into a rich media message; and
providing the rich media message to the second user device.

2. The method of claim 1, wherein the one or more rich media elements comprise an image, a meme, a video, an interactive element, or an animated element.

3. The method of claim 1, wherein the one or more rich media elements are customized by an artist to represent the one or more contextual tags.

4. The method of claim 1, wherein:
the one or more rich media elements comprise a background image and a character icon image; and
the rich media message comprises a composite arrangement of the background image, the character icon image, and the textual portion of the electronic message, the composite arrangement visually providing the context of the textual portion.

5. The method of claim 1, wherein the rich media message, when displayed on the second user device, is configured to display the one or more contextual tags, dates the one or more rich media elements were rendered, dates the one or more rich media elements were uploaded, locations the one or more rich media elements have been associated with, buildings that the one or more rich media elements have been associated with, one or more artists who created the one or more rich media elements, or semantics associated with the one or more rich media elements.

6. The method of claim 1, wherein recommending the one or more contextual tags is based at least in part on language characteristics of the textual portion.

7. The method of claim 1, wherein recommending the one or more contextual tags is based at least in part on a location of the first user device when the first user device provided the textual portion.

8. The method of claim 1, wherein recommending the one or more contextual tags is based at least in part on a checkin history of the first user device.

9. The method of claim 1, wherein recommending the one or more contextual tags is based at least in part on social data associated with the first user device.

10. The method of claim 1, wherein recommending the one or more contextual tags comprises:
ranking relevance of a plurality of the one or more tags with respect to the textual portion; and
providing a ranked list of contextual tags.

11. The method of claim 1, wherein the recommending the one or more contextual tags comprises adaptively choosing the one or more contextual tags for the first user device based on a tagging history of the first user device.

12. The method of claim 1, wherein the recommending one or more rich media elements comprises retrieving the one or more rich media elements from a rich media element datastore.

13. The method of claim 1, wherein the recommending one or more rich media elements comprises determining whether the one or more rich media elements represent the one or more contextual elements, and if not, requesting rendition of the one or more rich media elements.

14. The method of claim 1, wherein the providing the rich media message to the second user device comprises instructing an application on the second user device to display the rich media message.

15. The method of claim 14, wherein the application comprises a native messaging application on the second user device.

16. The method of claim 14, wherein the application comprises a social networking application on the second user device.

17. The method of claim 1, further comprising receiving from the first user device one or more approved contextual tags; and wherein the recommending the one or more rich media elements is based at least in part on the one or more approved contextual tags.

18. The method of claim 1, further comprising receiving from the first user device one or more approved rich media elements, and wherein the integrating the one or more rich media elements comprises integrating the one or more approved rich media elements into the rich media message.

19. A system comprising:
a tag datastore, a rich media element datastore, and a rich media message datastore;
a first user device interface engine configured to interface with a first user device;
a tag recommendation engine coupled to the tag datastore;
a rich media element recommendation engine coupled to the rich media element datastore;
a rich media creation engine coupled to the rich media message datastore; and
a second user device interface engine configured to interface with a second user device;
wherein, in operation:
the user device interface engine receives a textual portion of an electronic message from the first user device to the second user device;
the tag recommendation engine recommends one or more contextual tags to represent a context of the textual portion, the recommending the one or more contextual tags based at least in part on the receiving the textual portion;
the rich media element recommendation engine recommends the context of the textual portion, the recommending the one or more rich media elements based at least in part on the one or more contextual tags;
the rich media message creation engine integrates the one or more rich media elements and the textual portion into a rich media message; and
the second user device interface engine provides the rich media message to the second user device.

20. A system comprising:
means for receiving a textual portion of an electronic message from a first user device to a second user;
means for recommending one or more contextual tags to represent a context of the textual portion, the recommending the one or more contextual tags based at least in part on the receiving the textual portion;
means for recommending one or more rich media elements to represent the context of the textual portion, the recommending the one or more rich media elements based at least in part on the one or more contextual tags;
means for integrating the one or more rich media elements and the textual portion into a rich media message; and
means for providing the rich media message to the second user.
